(19) United States
(12) Patent Application Publication
(10) Pub. No.: US 2024/0206033 A1
(43) Pub. Date: Jun. 20, 2024

(54) LOAD CONTROL DEVICE FOR A LIGHT-EMITTING DIODE LIGHT SOURCE HAVING DIFFERENT OPERATING MODES

(71) Applicant: Lutron Technology Company LLC, Coopersburg, PA (US)

(72) Inventor: Steven J. Kober, Center Valley, PA (US)

(73) Assignee: Lutron Technology Company LLC, Coopersburg, PA (US)

(21) Appl. No.: 18/588,465

(22) Filed: Feb. 27, 2024

Related U.S. Application Data
(63) Continuation of application No. 18/310,608, filed on May 2, 2023, now Pat. No. 11,950,336.
Application No. 18/310,608 is a continuation of application No. 17/705,823, filed on Mar. 28, 2022, now Pat. No. 11,678,416.
Application No. 17/705,823 is a continuation of application No. 17/224,265, filed on Apr. 7, 2021, now Pat. No. 11,291,093.
Application No. 17/224,265 is a continuation of application No. 16/870,869, filed on May 8, 2020, now Pat. No. 10,986,709.
Application No. 16/870,869 is a continuation of application No. 16/664,086, filed on Oct. 25, 2019, now Pat. No. 10,652,978.
Application No. 16/664,086 is a continuation of application No. 16/402,318, filed on May 3, 2019, now Pat. No. 10,462,867.
Application No. 16/402,318 is a continuation of application No. 16/118,419, filed on Aug. 30, 2018, now Pat. No. 10,306,723.
Application No. 16/118,419 is a continuation of application No. 15/703,300, filed on Sep. 13, 2017, now Pat. No. 10,098,196.
(60) Provisional application No. 62/395,505, filed on Sep. 16, 2016.

(51) Int. Cl. H05B 45/327; H05B 45/10; H05B 45/14; H05B 45/37; H05B 45/382; H05B 45/39; H05B 45/395

(52) U.S. Cl. CPC H05B 45/327; H05B 45/10; H05B 45/37; H05B 45/382; H05B 45/39; H05B 45/395; H05B 45/14

(57) ABSTRACT

A load control device for regulating an average magnitude of a load current conducted through an electrical load may operate in different modes. The load control device may comprise a control circuit configured to activate an inverter circuit during an active state period and deactivate the inverter circuit during an inactive state period. In one mode, the control circuit may adjust the average magnitude of the load current by adjusting the inactive state period while keeping the active state period constant. In another mode, the control circuit may adjust the average magnitude of the load current by adjusting the active state period while keeping the inactive state period constant. In yet another mode, the control circuit may keep a duty cycle of the inverter circuit constant and regulate the average magnitude of the load current by adjusting a target load current conducted through the electrical load.

### CROSS-REFERENCE TO RELATED APPLICATIONS

This application is a continuation of U.S. patent application Ser. No. 18/310,608, filed May 2, 2023; which is a continuation of U.S. patent application Ser. No. 17/705,823, filed Mar. 28, 2022, now U.S. Pat. No. 11,678,416, issued Jun. 13, 2023; which is a continuation of U.S. patent application Ser. No. 17/224,265, filed on Apr. 7, 2021, now U.S. Pat. No. 11,291,093, issued Mar. 29, 2022; which is a continuation of U.S. patent application Ser. No. 16/870,869, filed May 8, 2020, now U.S. Pat. No. 10,986,709, issued on Apr. 20, 2021; which is a continuation of U.S. patent application Ser. No. 16/664,086, filed Oct. 25, 2019, now U.S. Pat. No. 10,652,978, issued on May 12, 2020; which is a continuation of U.S. patent application Ser. No. 16/402,318, filed May 3, 2019, now U.S. Pat. No. 10,462,867, issued on Oct. 29, 2019; which is a continuation of U.S. patent application Ser. No. 16/118,419, filed Aug. 30, 2018, now U.S. Pat. No. 10,306,723, issued on May 28, 2019; which is a continuation of U.S. patent application Ser. No. 15/703,300, filed Sep. 13, 2017, now U.S. Pat. No. 10,098,196, issued on Oct. 9, 2018; which claims the benefit of U.S. Provisional Patent Application No. 62/395,505, filed Sep. 16, 2016, the entire disclosures of which are hereby incorporated by reference.

### BACKGROUND

Light-emitting diode (LED) light sources (e.g., LED light engines) are replacing conventional incandescent, fluorescent, and halogen lamps as a primary form of lighting devices. LED light sources may comprise a plurality of light-emitting diodes mounted on a single structure and provided in a suitable housing. LED light sources may be more efficient and provide longer operational lives as compared to incandescent, fluorescent, and halogen lamps. An LED driver control device (e.g., an LED driver) may be coupled between an alternating-current (AC) power source and an LED light source for regulating the power supplied to the LED light source. For example, the LED driver may regulate the voltage provided to the LED light source, the current supplied to the LED light source, or both the current and voltage.

Different control techniques may be employed to drive LED light sources including, for example, a current load control technique and a voltage load control technique. An LED light source driven by the current load control technique may be characterized by a rated current (e.g., approximately 350 milliamps) to which the peak magnitude of the current through the LED light source may be regulated to ensure that the LED light source is illuminated to the appropriate intensity and/or color. An LED light source driven by the voltage load control technique may be characterized by a rated voltage (e.g., approximately 15 volts) to which the voltage across the LED light source may be regulated to ensure proper operation of the LED light source. If an LED light source rated for the voltage load control technique includes multiple parallel strings of LEDs, a current balance regulation element may be used to ensure that the parallel strings have the same impedance so that the same current is drawn in each of the parallel strings.

The light output of an LED light source may be dimmed. Methods for dimming an LED light source may include, for example, a pulse-width modulation (PWM) technique and a constant current reduction (CCR) technique. In pulse-width modulation dimming, a pulsed signal with a varying duty cycle may be supplied to the LED light source. For example, if the LED light source is being controlled using a current load control technique, the peak current supplied to the LED light source may be kept constant during an on time of the duty cycle of the pulsed signal. The duty cycle of the pulsed signal may be varied, however, to vary the average current supplied to the LED light source, thereby changing the intensity of the light output of the LED light source. As another example, if the LED light source is being controlled using a voltage load control technique, the voltage supplied to the LED light source may be kept constant during the on time of the duty cycle of the pulsed signal. The duty cycle of the load voltage may be varied, however, to adjust the intensity of the light output. Constant current reduction dimming may be used if an LED light source is being controlled using the current load control technique. In constant current reduction dimming, current may be continuously provided to the LED light source. The DC magnitude of the current provided to the LED light source, however, may be varied to adjust the intensity of the light output. Examples of LED drivers are described in greater detail in commonly-assigned U.S. Pat. No. 8,492,987, issued Jul. 23, 2010, and U.S. Patent Application Publication No. 2013/0063047, published Mar. 14, 2013, both entitled LOAD CONTROL DEVICE FOR A LIGHT-EMITTING DIODE LIGHT SOURCE, the entire disclosures of which are hereby incorporated by reference.

Dimming an LED light source using traditional techniques may result in changes in the light intensity that are perceptible to the human vision. This problem may be more apparent if the dimming occurs while the LED light source is near a low end of its intensity range (e.g., below 5% of a rated peak intensity). Accordingly, methods and apparatus for fine dimming of an LED light source may be desirable.

### SUMMARY

As described herein, a load control device for controlling the amount of power delivered to an electrical load may comprise a load regulation circuit. The load regulation circuit may be configured to control a magnitude of a load current conducted through the electrical load in order to control the amount of power delivered to the electrical load. The load regulation circuit may comprise an inverter circuit characterized by a burst duty cycle. The burst duty cycle may represent a ratio of an active state period in which the inverter circuit is activated and an inactive state period in which the inverter circuit is deactivated. The load control device may further comprise a control circuit coupled to the load regulation circuit and configured to control an average magnitude of the load current conducted through the electrical load. The control circuit may be configured to activate the inverter circuit during the active state period and deactivate the inverter circuit during the inactive state period. The control circuit may be further configured to operate in at least a low-end mode, an intermediate mode, and a normal mode. During the low-end mode, the control circuit is configured to keep the length of the active state period constant and adjust the length of the inactive state period in order to adjust the burst duty cycle of the inverter circuit and the average magnitude of the load current. During the intermediate mode, the control circuit is configured to keep the length of the inactive state period constant and adjust the length of the active state period in order to adjust the burst duty cycle of the inverter circuit and the average magnitude of the load current. During the normal mode, the control circuit is configured to regulate the average magnitude of the load current by holding the burst duty cycle constant and adjusting a target load current conducted through the electrical load.

Also described herein is an LED driver for controlling an intensity of an LED light source. The LED driver may comprise an LED drive circuit configured to control a magnitude of a load current conducted through the LED light source in order to achieve a target intensity of the LED light source. The LED drive circuit may in turn comprise an inverter circuit characterized by a burst duty cycle. The burst duty cycle may represent a ratio of an active state period in which the inverter circuit is activated and an inactive state period in which the inverter circuit is deactivated.

The LED driver may further comprise a control circuit coupled to the LED drive circuit and configured to control an average magnitude of the load current. The control circuit may be configured to activate the inverter circuit during the active state period and deactivate the inverter circuit during the inactive state period. The control circuit may be further configured to operate in a burst mode and a normal mode. During the normal mode, the control circuit may be configured to regulate the average magnitude of the load current by holding the burst duty cycle constant and adjusting a target load current conducted through the LED light source. During the burst mode, the control circuit may be configured to adjust the burst duty cycle and the average magnitude of the load current by keeping the length of the active state period constant and adjusting a length of the inactive state periods if the target intensity of the LED light source is within a first intensity range. During the burst mode, the control circuit may be configured to adjust the burst duty cycle and the average magnitude of the load current by keeping the length of the inactive state period constant and adjusting the length of the active state period if the target intensity of the LED light source is within a second intensity range. The second intensity range may be above the first intensity range in terms of intensity levels comprised in the respective intensity ranges. For example, the first intensity range may comprise intensity levels that are between 1% and 4% of a maximum rated intensity of the LED light source, and the second intensity range may comprise intensity levels that are between 4% and 5% of the maximum rated intensity of the LED light source.

### BRIEF DESCRIPTION OF THE DRAWINGS

FIG. 1 is a simplified block diagram of a light-emitting diode (LED) driver for controlling the intensity of an LED light source.

FIG. 2 is an example plot of a target load current of the LED driver of FIG. 1 as a function of a target intensity.

FIG. 3 is an example plot of a burst duty cycle of the LED driver of FIG. 1 as a function of the target intensity.

FIG. 4 is an example state diagram illustrating the operation of a load regulation circuit of the LED driver of FIG. 1 when operating in a burst mode.

FIG. 5 is a simplified schematic diagram of an isolated forward converter and a current sense circuit of an LED driver.

FIG. 6 is an example diagram illustrating a magnetic core set of an energy-storage inductor of a forward converter.

FIG. 7 shows example waveforms illustrating the operation of a forward converter and a current sense circuit when the intensity of an LED light source is near a high-end intensity.

FIG. 8 shows example waveforms illustrating the operation of a forward converter and a current sense circuit when the intensity of an LED light source is near a low-end intensity.

FIG. 9 shows example waveforms illustrating the operation of a forward converter of an LED driver when operating in a burst mode.

FIG. 10 shows a diagram of an example waveform illustrating a load current when a load regulation circuit is operating in a burst mode.

FIG. 11 shows an example plot illustrating how a relative average light level may change as a function of a number of inverter cycles included in an active state period when a load regulation circuit is operating in a burst mode.

FIG. 12 shows example waveforms illustrating a load current when a control circuit of the LED driver of FIG. 1 is operating in a burst mode.

FIG. 13 shows an example of a plot relationship between a target load current and the lengths of an active state period and an inactive state period when a load regulation circuit is operating in a burst mode.

FIG. 14 shows a simplified flowchart of an example procedure for operating a LED drive circuit of an LED driver in a normal mode and a burst mode.

### DETAILED DESCRIPTION

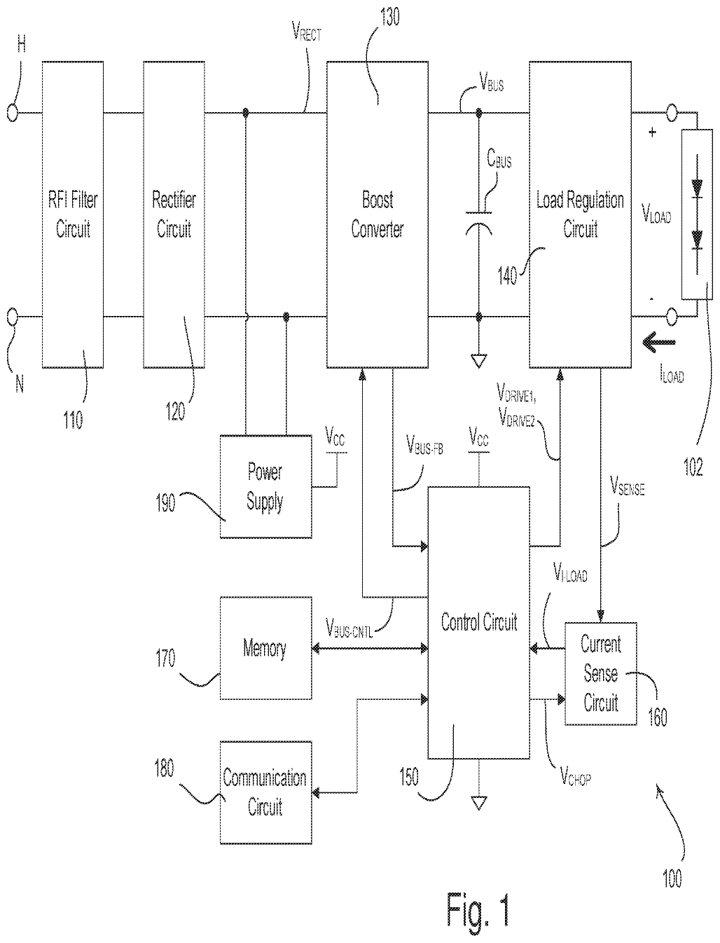

FIG. 1 is a simplified block diagram of a load control device, e.g., a light-emitting diode (LED) driver 100, for controlling the amount of power delivered to an electrical load, such as, an LED light source 102 (e.g., an LED light engine), and thus the intensity of the electrical load. The LED light source 102 is shown as a plurality of LEDs connected in series but may comprise a single LED or a plurality of LEDs connected in parallel or a suitable combination thereof, depending on the particular lighting system. The LED light source 102 may comprise one or more organic light-emitting diodes (OLEDs). The light source 102 may comprise one or more quantum dot light-emitting diodes (QLEDs). The LED driver 100 may comprise a hot terminal H and a neutral terminal. The terminals may be adapted to be coupled to an alternating-current (AC) power source (not shown).

The LED driver 100 may comprise a radio-frequency interference (RFI) filter circuit 110, a rectifier circuit 120, a boost converter 130, a load regulation circuit 140, a control circuit 150, a current sense circuit 160, a memory 170, a communication circuit 180, and/or a power supply 190. The RFI filter circuit 110 may minimize the noise provided on the AC mains. The rectifier circuit 120 may generate a rectified voltage V_{RECT}.

The boost converter 130 may receive the rectified voltage V_{RECT} and generate a boosted direct-current (DC) bus voltage V_{BUS} across a bus capacitor C_{BUS}. The boost converter 130 may comprise any suitable power converter circuit for generating an appropriate bus voltage, such as, for example, a flyback converter, a single-ended primary-inductor converter (SEPIC), a Ćuk converter, or other suitable power converter circuit. The boost converter 120 may operate as a power factor correction (PFC) circuit to adjust the power factor of the LED driver 100 towards a power factor of one.

The load regulation circuit 140 may receive the bus voltage V_{BUS} and control the amount of power delivered to the LED light source 102, for example, to control the intensity of the LED light source 102 between a low-end (e.g., minimum) intensity L_{LE} (e.g., approximately 1-5%) and a high-end (e.g., maximum) intensity L_{HE} (e.g., approximately 100%). An example of the load regulation circuit 140 may be an isolated, half-bridge forward converter. An example of the load control device (e.g., LED driver 100) comprising a forward converter is described in greater detail in commonly-assigned U.S. patent application Ser. No. 13/935,799, filed Jul. 5, 2013, entitled LOAD CONTROL DEVICE FOR A LIGHT-EMITTING DIODE LIGHT SOURCE, the entire disclosure of which is hereby incorporated by reference. The load regulation circuit 140 may comprise, for example, a buck converter, a linear regulator, or any suitable LED drive circuit for adjusting the intensity of the LED light source 102.

The control circuit 150 may be configured to control the operation of the boost converter 130 and/or the load regulation circuit 140. An example of the control circuit 150 may be a controller. The control circuit 150 may comprise, for example, a digital controller or any other suitable processing device, such as, for example, a microcontroller, a programmable logic device (PLD), a microprocessor, an application specific integrated circuit (ASIC), or a field-programmable gate array (FPGA). The control circuit 150 may generate a bus voltage control signal V_{BUS-CNTL}, which may be provided to the boost converter 130 for adjusting the magnitude of the bus voltage V_{BUS}. The control circuit 150 may receive a bus voltage feedback control signal V_{BUS-FB} from the boost converter 130, which may indicate the magnitude of the bus voltage V_{BUS}.

The control circuit 150 may generate drive control signals V_{DRIVE1}, V_{DRIVE2}. The drive control signals V_{DRIVE1}, V_{DRIVE2} may be provided to the load regulation circuit 140 for adjusting the magnitude of a load voltage V_{LOAD} generated across the LED light source 102 and/or the magnitude of a load current I_{LOAD} conducted through the LED light source 120. By controlling the load voltage V_{LOAD} and/or the load current I_{LOAD}, the control circuit may control the intensity of the LED light source 120 to a target intensity L_{TRGT}. The control circuit 150 may adjust an operating frequency f_{OP} and/or a duty cycle DC_{INV} (e.g., an on time T_{ON}) of the drive control signals V_{DRIVE1}, V_{DRIVE2} in order to adjust the magnitude of the load voltage V_{LOAD} and/or the load current I_{LOAD}.

The current sense circuit 160 may receive a sense voltage V_{SENSE}. The sense voltage V_{SENSE} may be generated by the load regulation circuit 140. The sense voltage V_{SENSE} may indicate the magnitude of the load current I_{LOAD}. The current sense circuit 160 may receive a signal-chopper control signal V_{CHOP} from the control circuit 150. The current sense circuit 160 may generate a load current feedback signal V_{I-LOAD}, which may be a DC voltage indicating the average magnitude I_{AVE} of the load current I_{LOAD}. The control circuit 150 may receive the load current feedback signal V_{I-LOAD} from the current sense circuit 160. The control circuit 150 may adjust the drive control signals V_{DRIVE1}, V_{DRIVE2} based on the load current feedback signal V_{I-LOAD} so that the magnitude of the load current I_{LOAD} may be adjusted towards a target load current I_{TRGT}. For example, the control circuit 150 may set initial operating parameters for the drive control signals V_{DRIVE1}, V_{DRIVE2} (e.g., an operating frequency f_{OP} and/or a duty cycle DC_{INV}). The control circuit 150 may receive the load current feedback signal V_{I-LOAD} indicating the effect of the drive control signals V_{DRIVE1}, V_{DRIVE2}. Based on the indication, the control circuit 150 may adjust the operating parameters of the drive control signals to thus adjust the magnitude of the load current I_{LOAD} towards a target load current I_{TRGT} (e.g., using a control loop).

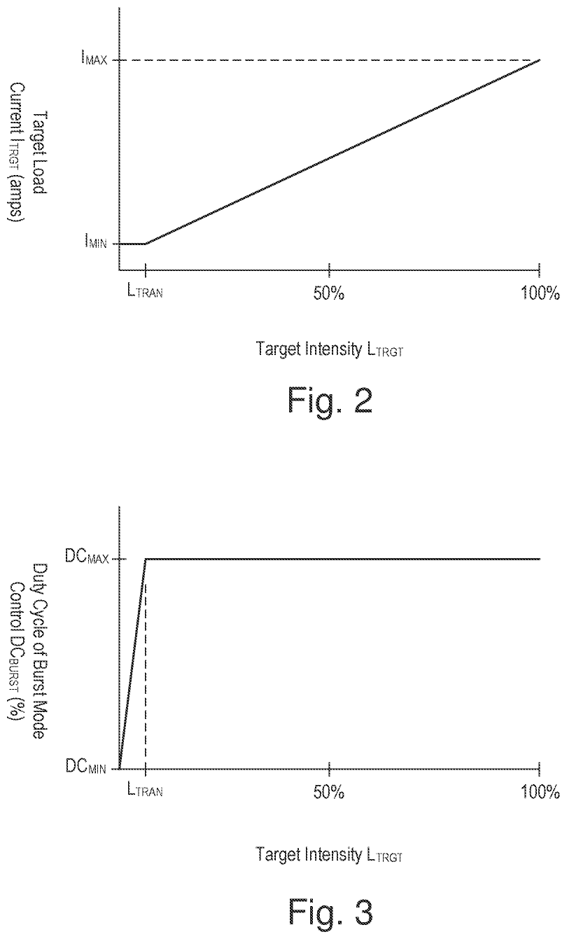

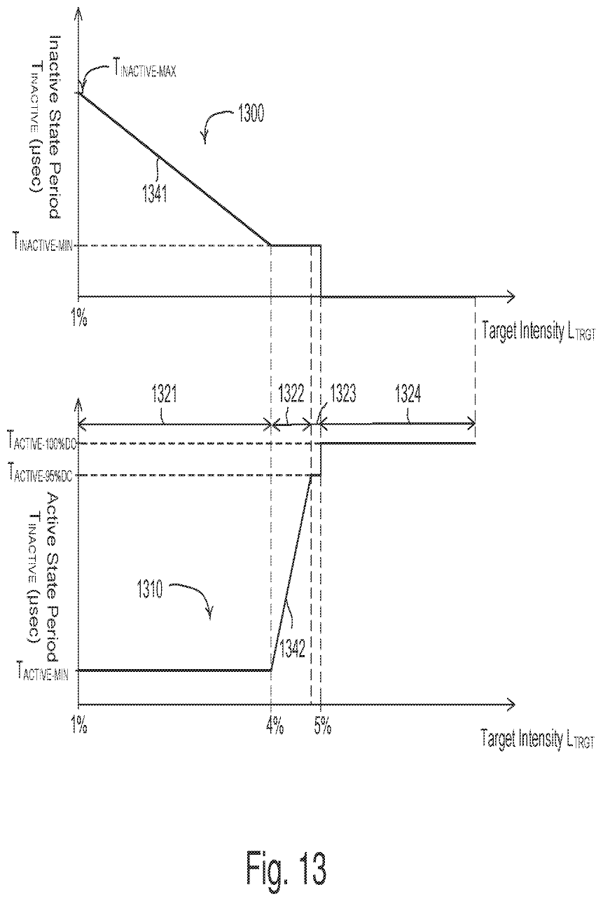

The load current I_{LOAD} may be the current that is conducted through the LED light source 102. The target load current I_{TRGT} may be the current that the control circuit 150 aims to conduct through the LED light source 102 (e.g., based at least on the load current feedback signal V_{I-LOAD}). The load current I_{LOAD} may be approximately equal to the target load current I_{TRGT} but may not always follow the target load current T_{TRGT}. This may be because, for example, the control circuit 150 may have specific levels of granularity in which it can control the current conducted through the LED light source 102 (e.g., due to inverter cycle lengths, etc.). Non-ideal reactions of the LED light source 102 (e.g., an overshoot in the load current I_{LOAD}) may also cause the load current I_{LOAD} to deviate from the target load current I_{TRGT}. A person skilled in the art will appreciate that the figures shown herein (e.g., FIGS. 2 and 13) that illustrate the current conducted through an LED light source as a linear graph illustrate the target load current I_{TRGT} since the load current I_{LOAD} itself may not actually follow a true linear path.

The control circuit 150 may be coupled to the memory 170. The memory 170 may store operational characteristics of the LED driver 100 (e.g., the target intensity L_{TRGT}, the low-end intensity L_{LE}, the high-end intensity L_{HE}, etc.). The communication circuit 180 may be coupled to, for example, a wired communication link or a wireless communication link, such as a radio-frequency (RF) communication link or an infrared (IR) communication link. The control circuit 150 may be configured to update the target intensity L_{TRGT} of the LED light source 102 and/or the operational characteristics stored in the memory 170 in response to digital messages received via the communication circuit 180. The LED driver 100 may be operable to receive a phase-control signal from a dimmer switch for determining the target intensity L_{TRGT} for the LED light source 102. The power supply 190 may receive the rectified voltage V_{RECT} and generate a direct-current (DC) supply voltage V_{CC} for powering the circuitry of the LED driver 100.

FIG. 2 is an example plot of the target load current I_{TRGT} as a function of the target intensity L_{TRGT}. As shown, a linear relationship may exist between the target intensity L_{TRGT} and the target load current I_{TRGT} (e.g., in at least an ideal situation). For example, to achieve a higher target intensity, the control circuit 150 may increase the target load current I_{TRGT} (e.g., in proportion to the increase in the target intensity); to achieve a lower target intensity, the control circuit 150 may decrease the target load current I_{TRGT} (e.g., in proportion to the decrease in the target intensity). As the target load current I_{TRGT} is being adjusted, the magnitude of the load current I_{LOAD} may change accordingly. There may be limits, however, to how much the load current I_{LOAD} may be adjusted. For example, the load current I_{LOAD} may not be adjusted above a maximum rated current I_{MAX} or below a minimum rated current T_{MIN} (e.g., due to hardware limitations of the load regulation circuit 140 and/or the control circuit 150). Therefore, the control circuit 150 may be configured to adjust the target load current I_{TRGT} between the minimum rated current I_{MIN} and a maximum rated current I_{MAX} so that the magnitude of the load current I_{LOAD} may fall in the same range. The maximum rated current I_{MAX} may correspond to a high-end intensity L_{HE} (e.g., approximately 100%). The minimum rated current I_{MIN} may correspond to a transition intensity L_{TRAN} (e.g., approximately 5%). Between the high-end intensity L_{HE} and the transition intensity L_{TRAN}, the control circuit 150 may operate the load regulation circuit 140 in a normal mode in which an average magnitude I_{AVE} of the load current I_{LOAD} may be controlled to be equal (e.g., approximately equal) to the target load current I_{TRGT}. During the normal mode, the control circuit 150 may control the average magnitude I_{AVE} of the load current I_{LOAD} to the target load current I_{TRGT} in response to the load current feedback signal V_{I-LOAD} (e.g., using closed loop control), for example.

To adjust the average magnitude I_{AVE} of the load current I_{LOAD} to below the minimum rated current I_{MIN} (and to thus adjust the target intensity L_{TRGT} below the transition intensity L_{TRAN}), the control circuit 150 may be configured to operate the load regulation circuit 140 in a burst mode. The burst mode may be characterized by a burst operating period that includes an active state period and an inactive state period. During the active state period, the control circuit 150 may be configured to regulate the load current I_{LOAD} in ways similar to those in the normal mode. During the inactive state period, the control circuit 150 may be configured to stop regulating the load current I_{LOAD} (e.g., to allow the load current I_{LOAD} to drop to approximately zero). The ratio of the active state period to the burst operating period, e.g., T_{ACTIVE}/T_{BURST}, may represent a burst duty cycle DC_{BURST}. The burst duty cycle DC_{BURST} may be controlled between a maximum duty cycle DC_{MAX} (e.g., approximately 100%) and a minimum duty cycle DC_{MIN} (e.g., approximately 20%). The load current I_{LOAD} may be adjusted towards the target current I_{TRGT} (e.g., the minimum rated current I_{MIN}) during the active state period of the burst mode. Setting the burst duty cycle DC_{BURST} to a value less than the maximum duty cycle DC_{MAX} may reduce the average magnitude I_{AVE} of the load current I_{LOAD} to below the minimum rated current I_{MIN}.

FIG. 3 is an example plot of a burst duty cycle DC_{BURST} (e.g., an ideal burst duty cycle DC_{BURST-IDEAL}) as a function of the target intensity L_{TRGT}. As described herein, when the target intensity L_{TRGT} is between the high-end intensity L_{HE} (e.g., approximately 100%) and the transition intensity L_{TRAN} (e.g., approximately 5%), the control circuit 150 may be configured to operate the load regulation circuit 140 in the normal mode, e.g., by setting the burst duty cycle DC_{BURST} at a constant value that is equal to approximately a maximum duty cycle DC_{MAX} or approximately 100%. To adjust the target intensity L_{TRGT} below the transition intensity L_{TRAN}, the control circuit 150 may be configured to operate the load regulation circuit 140 in the burst mode, e.g., by adjusting the burst duty cycle DC_{BURST} between the maximum duty cycle DC_{MAX} and the minimum duty cycle DC_{MIN} (e.g., approximately 20%).

With reference to FIG. 3, the burst duty cycle DC_{BURST} may refer to an ideal burst duty cycle DC_{BURST-IDEAL}, which may include an integer portion DC_{BURST-INTEGER} and/or a fractional portion DC_{BURST-FRACTIONAL}. The integer portion DC_{BURST-INTEGER} may be characterized by the percentage of the ideal burst duty cycle DC_{BURST-IDEAL} that includes complete inverter cycles (e.g., an integer value of inverter cycles). The fractional portion DC_{BURST-FRACTIONAL} may be characterized by the percentage of the ideal burst duty cycle DC_{BURST-IDEAL} that includes a fraction of an inverter cycle. In at least some cases, the control circuit 150 (e.g., via the load regulation circuit 140) may be configured to adjust the number of inverter cycles by an integer number (e.g., by DC_{BURST-INTEGER}) and not a fractional amount (e.g., DC_{BURST-FRACTIONAL}). Therefore, although the example plot of FIG. 3 illustrates an ideal curve showing continuous adjustment of the ideal burst duty cycle DC_{BURST-IDEAL} from a maximum duty cycle DC_{MAX} to a minimum duty cycle DC_{MIN}, unless defined differently, burst duty cycle DC_{BURST} may refer to the integer portion DC_{BURST-INTEGER} of the ideal burst duty cycle DC_{BURST-IDEAL} (e.g., if the control circuit 150 is not be configured to operate the burst duty cycle DC_{BURST} at fractional amounts).

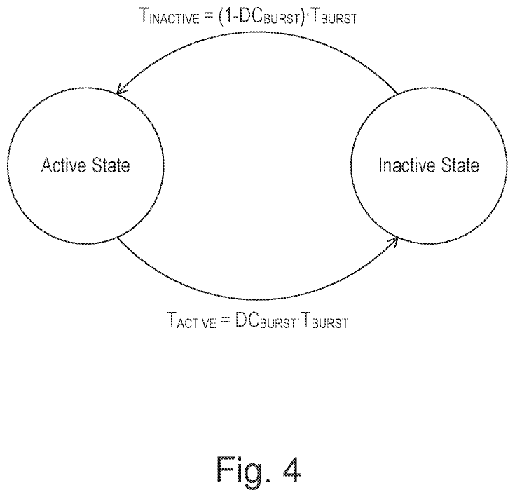

FIG. 4 is an example state diagram illustrating the operation of the load regulation circuit 140 in the burst mode. During the burst mode, the control circuit 150 may periodically control the load regulation circuit 140 into an active state and an inactive state, e.g., in dependence upon a burst duty cycle DC_{BURST} and a burst mode period T_{BURST} (e.g., approximately 4.4 milliseconds). For example, the active state period T_{ACTIVE} may be equal to the burst duty cycle DC_{BURST} times the burst mode period T_{BURST} and the inactive state period T_{INACTIVE} may be equal to one minus the burst duty cycle DC_{BURST} times the burst mode period T_{BURST}. That is, T_{ACTIVE}=DC_{BURST}−T_{BURST} and T_{INACTIVE}=(1−DC_{BURST})−T_{BURST}.

In the active state of the burst mode, the control circuit 150 may be configured to generate the drive control signals V_{DRIVE1}, V_{DRIVE2}. The control circuit 150 may be further configured to adjust the operating frequency f_{OP} and/or the duty cycle DC_{INV} (e.g., an on time T_{ON}) of the drive control signals V_{DRIVE1}, V_{DRIVE2} to adjust the magnitude of the load current I_{LOAD}. The control circuit 150 may be configured to make the adjustments using closed loop control. For example, in the active state of the burst mode, the control circuit 150 may generate the drive signals V_{DRIVE1}, V_{DRIVE2} to adjust the magnitude of the load current I_{LOAD} to be equal to a target load current I_{TRGT} (e.g., the minimum rated current I_{MIN}) in response to the load current feedback signal V_{I-LOAD}.

In the inactive state of the burst mode, the control circuit 150 may let the magnitude of the load current I_{LOAD} drop to approximately zero amps, e.g., by freezing the closed loop control and/or not generating the drive control signals V_{DRIVE1}, V_{DRIVE2}. While the control loop is frozen (e.g., in the inactive state), the control circuit 150 may stop responding to the load current feedback signal V_{I-LOAD} (e.g., the control circuit 150 may not adjust the values of the operating frequency f_{OP} and/or the duty cycle DC_{INV} in response to the load current feedback signal). The control circuit 150 may store the present duty cycle DC_{INV} (e.g., the present on time T_{ON}) of the drive control signals V_{DRIVE1}, V_{DRIVE2} in the memory 170 prior to (e.g., immediately prior to) freezing the control loop. When the control loop is unfrozen (e.g., when the control circuit 150 enters the active state), the control circuit 150 may resume generating the drive control signals V_{DRIVE1}, V_{DRIVE2} using the operating frequency f_{OP} op and/or the duty cycle DC_{INV} from the previous active state.

The control circuit 150 may be configured to adjust the burst duty cycle DC_{BURST} using an open loop control. For example, the control circuit 150 may be configured to adjust the burst duty cycle DC_{BURST} as a function of the target intensity L_{TRGT} when the target intensity L_{TRGT} is below the transition intensity L_{TRAN}. For example, the control circuit 150 may be configured to linearly decrease the burst duty cycle DC_{BURST} as the target intensity L_{TRGT} is decreased below the transition intensity L_{TRAN} (e.g., as shown in FIG. 3), while the target load current I_{TRGT} is held constant at the minimum rated current I_{MIN} (e.g., as shown in FIG. 2). Since the control circuit 150 may switch between the active state and the inactive state in dependence upon the burst duty cycle DC_{BURST} and the burst mode period T_{BURST} (e.g., as shown in the state diagram of FIG. 4), the average magnitude I_{AVE} of the load current I_{LOAD} may change as a function of the burst duty cycle DC_{BURST} (e.g., I_{AVE}=DC_{BURST}−I_{MIN}). In other words, during the burst mode, the peak magnitude I_{PK} of the load current I_{LOAD} may be equal to the minimum rated current I_{MIN}, but the average magnitude I_{AVE} of the load current I_{LOAD} may be less than the minimum rated current I_{MIN}, depending on the value of the burst duty cycle DC_{BURST}.

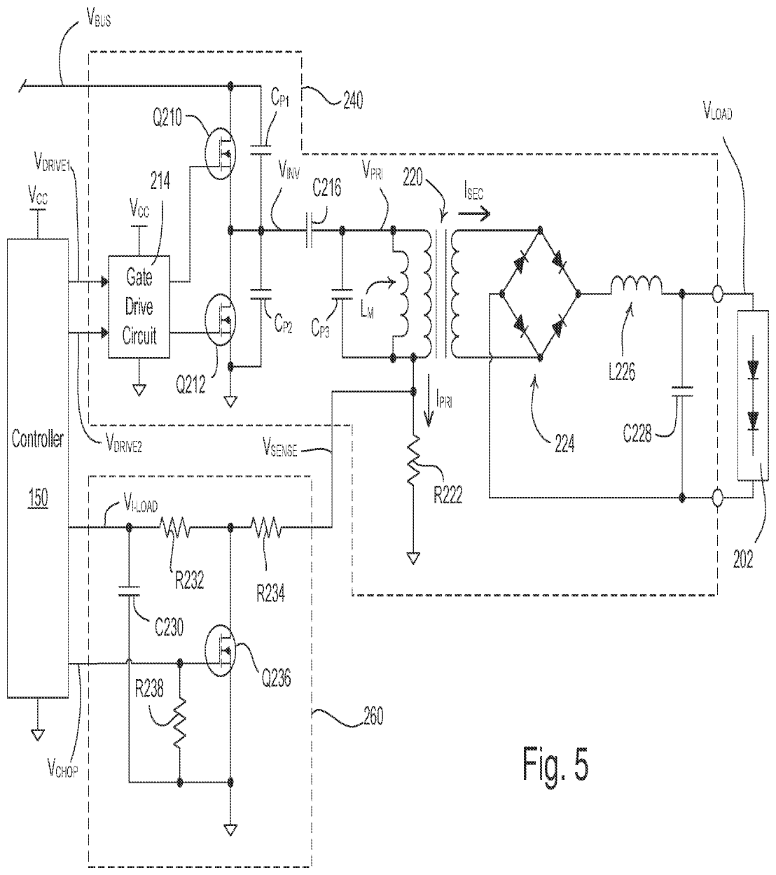

FIG. 5 is a simplified schematic diagram of a forward converter 240 and a current sense circuit 260 of an LED driver (e.g., the LED driver 100 shown in FIG. 1). The forward converter 240 may be an example of the load regulation circuit 140 of the LED driver 100 shown in FIG. 1. The current sense circuit 260 may be an example of the current sense circuit 160 of the LED driver 100 shown in FIG. 1.

The forward converter 240 may comprise a half-bridge inverter circuit having two field effect transistors (FETs) Q210, Q212 for generating a high-frequency inverter voltage V_{INV}, e.g., from the bus voltage V_{BUS}. The FETs Q210, Q212 may be rendered conductive and non-conductive in response to the drive control signals V_{DRIVE1}, V_{DRIVE2}. The drive control signals V_{DRIVE1}, V_{DRIVE2} may be received from the control circuit 150. The drive control signals V_{DRIVE1}, V_{DRIVE2} may be coupled to the gates of the respective FETs Q210, Q212 via a gate drive circuit 214 (e.g., which may comprise part number L6382DTR, manufactured by ST Microelectronics). The control circuit 150 may be configured to generate the inverter voltage V_{INV} at an operating frequency f_{OP} (e.g., approximately 60-65 kHz) and thus an operating period T_{OP}. The control circuit 150 may be configured to adjust the operating frequency f_{OP} under certain operating conditions. For example, the control circuit 150 may be configured to decrease the operating frequency near the high-end intensity L_{HE}. The control circuit 150 may be configured to adjust a duty cycle DC_{INV} of the inverter voltage V_{INV} (e.g., with or without also adjusting the operating frequency) to control the intensity of an LED light source 202 towards the target intensity L_{TRGT}.

In a normal mode of operation, when the target intensity L_{TRGT} of the LED light source 202 is between the high-end intensity L_{HE} and the transition intensity L_{TRAN}, the control circuit 150 may adjust the duty cycle DC_{INV} of the inverter voltage V_{INV} to adjust the magnitude of the load current I_{LOAD} (e.g., the average magnitude I_{AVE}) towards the target load current I_{TRGT}. The magnitude of the load current I_{LOAD} may vary between the maximum rated current I_{MAX} and the minimum rated current I_{MIN} (e.g., as shown in FIG. 2). The minimum rated current I_{MIN} may be determined, for example, based on a minimum on time T_{ON-MIN} of the half-bridge inverter circuit of the forward converter 240. The minimum on time T_{ON-MIN} may vary based on hardware limitations of the forward converter. At the minimum rated current I_{MIN} (e.g., at the transition intensity L_{TRAN}), the inverter voltage V_{INV} may be characterized by a low-end operating frequency f_{OP-LE} and a low-end operating period T_{OP-LE}.

When the target intensity L_{TRGT} of the LED light source 202 is below the transition intensity L_{TRAN}, the control circuit 150 may be configured to operate the forward converter 240 in a burst mode of operation. In addition to or in lieu of using target intensity as a threshold for determining when to operate in burst mode, the control circuit 150 may use power (e.g., a transition power) and/or current (e.g., a transition current) as the threshold. In the burst mode of operation, the control circuit 150 may be configured to switch the forward converter 240 between an active state (e.g., in which the control circuit 150 may actively generate the drive control signals V_{DRIVE1}, V_{DRIVE2} to regulate the peak magnitude I_{PK} of the load current I_{LOAD} to be equal to the minimum rated current I_{MIN}) and an inactive state (e.g., in which the control circuit 150 freezes the control loop and does not generate the drive control signals V_{DRIVE1}, V_{DRIVE2}). FIG. 4 shows a state diagram illustrating the transmission between the two states. The control circuit 150 may switch the forward converter 240 between the active state and the inactive state in dependence upon a burst duty cycle DC_{BURST} and/or a burst mode period T_{BURST} (e.g., as shown in FIG. 4). The control circuit 150 may adjust the burst duty cycle DC_{BURST} as a function of the target intensity L_{TRGT}, which may be below the transition intensity L_{TRAN} (e.g., as shown in FIG. 3). In the active state of the burst mode (as well as in the normal mode), the forward converter 240 may be characterized by a turn-on time T_{TURN-ON} and a turn-off time T_{TURN-OFF}. The turn-on time T_{TURN-ON} may be a time period from when the drive control signals V_{DRIVE1}, V_{DRIVE2} are driven until the respective FET Q210, Q212 is rendered conductive. The turn-off time T_{TURN-OFF} may be a time period from when the drive control signals V_{DRIVE1}, V_{DRIVE2} are driven until the respective FET Q210, Q212 is rendered non-conductive.

The inverter voltage V_{INV} may be coupled to the primary winding of a transformer 220 through a DC-blocking capacitor C216 (e.g., which may have a capacitance of approximately 0.047 μF). A primary voltage V_{PRI} may be generated across the primary winding. The transformer 220 may be characterized by a turns ratio n_{TURNS} (e.g., N₁/N₂), which may be approximately 115:29. A sense voltage V_{SENSE} may be generated across a sense resistor R222, which may be coupled in series with the primary winding of the transformer 220. The FETs Q210, Q212 and the primary winding of the transformer 220 may be characterized by parasitic capacitances C_{P1}, C_{P2}, C_{P3}, respectively. The secondary winding of the transformer 220 may generate a secondary voltage. The secondary voltage may be coupled to the AC terminals of a full-wave diode rectifier bridge 224 for rectifying the secondary voltage generated across the secondary winding. The positive DC terminal of the rectifier bridge 224 may be coupled to the LED light source 202 through an output energy-storage inductor L226 (e.g., which may have an inductance of approximately 10 mH). The load voltage V_{LOAD} may be generated across an output capacitor C228 (e.g., which may have a capacitance of approximately 3 μF).

The current sense circuit 260 may comprise an averaging circuit for producing the load current feedback signal V_{I-LOAD}. The averaging circuit may include a low-pass filter. The low-pass filter may comprise a capacitor C230 (e.g., which may have a capacitance of approximately 0.066 uF) and a resistor R232 (e.g., which may have a resistance of approximately 3.32 kΩ). The low-pass filter may receive the sense voltage V_{SENSE} via a resistor R234 (e.g., which may have a resistance of approximately 1 kΩ). The current sense circuit 160 may comprise a transistor Q236 (e.g., a FET as shown in FIG. 5). The transistor Q236 may be coupled between the junction of the resistors R232, R234 and circuit common. The gate of the transistor Q236 may be coupled to circuit common through a resistor R238 (e.g., which may have a resistance of approximately 22 kΩ). The gate of the transistor Q236 may receive the signal-chopper control signal V_{CHOP} from the control circuit 150. An example of the current sense circuit 260 may be described in greater detail in commonly-assigned U.S. patent application Ser. No. 13/834,153, filed Mar. 15, 2013, entitled FORWARD CONVERTER HAVING A PRIMARY-SIDE CURRENT SENSE CIRCUIT, the entire disclosure of which is hereby incorporated by reference.

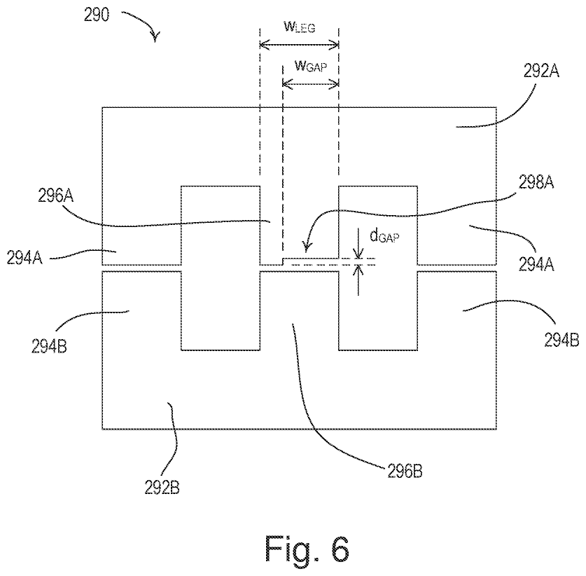

FIG. 6 is a diagram illustrating an example magnetic core set 290 of an energy-storage inductor (e.g., the output energy-storage inductor L226 of the forward converter 240 shown in FIG. 5). The magnetic core set 290 may comprise two E-cores 292A, 292B, and may comprise part number PC40EE16-Z, manufactured by TDK Corporation. The E-cores 292A, 292B may comprise respective outer legs 294A, 294B and inner legs 296A, 296B. The inner legs 296A, 296B may be characterized by a width w_{LEG} (e.g., approximately 4 mm). The inner leg 296A of the first E-core 292A may comprise a partial gap 298A (e.g., the magnetic core set 290 may be partially-gapped), such that the inner legs 296A, 296B may be spaced apart by a gap distance d_{GAP} (e.g., approximately 0.5 mm). The partial gap 298A may extend for a gap width w_{GAP} (e.g., approximately 2.8 mm) such that the partial gap 298A may extend for approximately 70% of the leg width w_{LEG} of the inner leg 296A. Either or both of the inner legs 296A, 296B may comprise partial gaps. The partially-gapped magnetic core set 290 (e.g., as shown in FIG. 6) may allow the output energy-storage inductor L226 of the forward converter 240 (e.g., shown in FIG. 5) to maintain continuous current at low load conditions (e.g., near the low-end intensity L_{LE}).

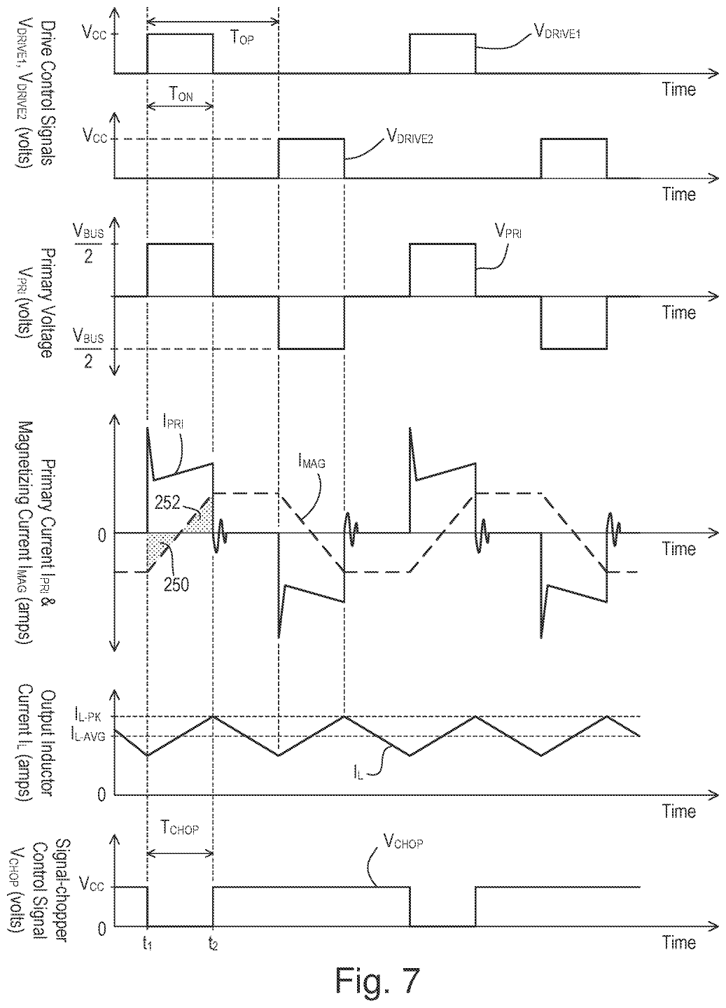

FIG. 7 shows waveforms illustrating example operation of a forward converter (e.g., the forward converter 240) and a current sense circuit (e.g., the current sense circuit 260). The forward converter 240 may generate the waveforms shown in FIG. 7, for example, when operating in the normal mode and in the active state of the burst mode as described herein. As shown in FIG. 7, a control circuit (e.g., the control circuit 150) may drive the respective drive control signals V_{DRIVE1}, V_{DRIVE2} high to approximately the supply voltage V_{CC} to render the respective FETs Q210, Q212 conductive for an on time T_{ON}. The FETs Q210, Q212 may be rendered conductive at different times. When the high-side FET Q210 is conductive, the primary winding of the transformer 220 may conduct a primary current I_{PRI} to circuit common, e.g., through the capacitor C216 and sense resistor R222. After (e.g., immediately after) the high-side FET Q210 is rendered conductive (at time t₁ in FIG. 7), the primary current I_{PRI} may exhibit a short high-magnitude pulse, e.g., due to the parasitic capacitance C_{P3} of the transformer 220 as shown in FIG. 7. While the high-side FET Q210 is conductive, the capacitor C216 may charge, such that a voltage having a magnitude of approximately half of the magnitude of the bus voltage V_{BUS} may be developed across the capacitor. The magnitude of the primary voltage V_{PRI} across the primary winding of the transformer 220 may be equal to approximately half of the magnitude of the bus voltage V_{BUS} (e.g., V_{BUS}/2). When the low-side FET Q212 is conductive, the primary winding of the transformer 220 may conduct the primary current I_{PRI} in an opposite direction and the capacitor C216 may be coupled across the primary winding, such that the primary voltage V_{PRI} may have a negative polarity with a magnitude equal to approximately half of the magnitude of the bus voltage V_{BUS}.

When either of the high-side and low-side FETs Q210, Q212 are conductive, the magnitude of an output inductor current I_{L} conducted by the output inductor L226 and/or the magnitude of the load voltage V_{LOAD} across the LED light source 202 may increase with respect to time. The magnitude of the primary current I_{PRI} may increase with respect to time while the FETs Q210, Q212 are conductive (e.g., after an initial current spike). When the FETs Q210, Q212 are non-conductive, the output inductor current I_{L} and the load voltage V_{LOAD} may decrease in magnitude with respective to time. The output inductor current I_{L} may be characterized by a peak magnitude I_{L-PK} and an average magnitude I_{L-AVG}, for example, as shown in FIG. 7. The control circuit 150 may increase and/or decrease the on times T_{ON} of the drive control signals V_{DRIVE1}, V_{DRIVE2} (e.g., and the duty cycle DC_{INV} of the inverter voltage V_{INV}) to respectively increase and/or decrease the average magnitude I_{L-AVG} of the output inductor current I_{L}, and thus respectively increase and/or decrease the intensity of the LED light source 202.

When the FETs Q210, Q212 are rendered non-conductive, the magnitude of the primary current I_{PRI} may drop toward zero amps (e.g., as shown at time t₂ in FIG. 7 when the high-side FET Q210 is rendered non-conductive). A magnetizing current I_{MAG} may continue to flow through the primary winding of the transformer 220, e.g., due to the magnetizing inductance L_{MAG} of the transformer. When the target intensity L_{TRGT} of the LED light source 102 is near the low-end intensity L_{LE}, the magnitude of the primary current I_{PRI} may oscillate after either of the FETs Q210, Q212 is rendered non-conductive. The oscillation may be caused by the parasitic capacitances C_{P1}, C_{P2} of the FETs, the parasitic capacitance C_{P3} of the primary winding of the transformer 220, and/or other parasitic capacitances of the circuit (e.g., such as the parasitic capacitances of the printed circuit board on which the forward converter 240 is mounted).

The real component of the primary current I_{PRI} may indicate the magnitude of the secondary current I_{SEC} and thus the intensity of the LED light source 202. The magnetizing current I_{MAG} (e.g., the reactive component of the primary current I_{PRI}) may flow through the sense resistor R222. When the high-side FET Q210 is conductive, the magnetizing current I_{MAG} may change from a negative polarity to a positive polarity. When the low-side FET Q212 is conductive, the magnetizing current I_{MAG} may change from a positive polarity to a negative polarity. When the magnitude of the primary voltage V_{PRI} is zero volts, the magnetizing current I_{MAG} may remain constant, for example, as shown in FIG. 7. The magnetizing current I_{MAG} may have a maximum magnitude defined by the following equation:

$${I}_{MAG - M A X} = \frac{{V}_{B U S} \cdot {T}_{H C}}{4 \cdot {L}_{MAG}} ,$$

where T_{HC} may be the half-cycle period of the inverter voltage V_{INV}, e.g., T_{HC}=T_{OP}/2. As shown in FIG. 7, the areas 250, 252 may be approximately equal such that the average value of the magnitude of the magnetizing current I_{MAG} may be zero during the period of time when the magnitude of the primary voltage V_{PRI} is greater than approximately zero volts (e.g., during the on time T_{ON} as shown in FIG. 7).

The current sense circuit 260 may determine an average of the primary current I_{PRI} during the positive cycles of the inverter voltage V_{INV}, e.g., when the high-side FET Q210 is conductive. As described herein, the high-side FET Q210 may be conductive during the on time T_{ON}. The current sense circuit 260 may generate a load current feedback signal V_{I-LOAD}, which may have a DC magnitude that is the average value of the primary current I_{PRI} (e.g., when the high-side FET Q210 is conductive). Because the average value of the magnitude of the magnetizing current I_{MAG} may be approximately zero during the period of time that the high-side FET Q210 is conductive (e.g., during the on time T_{ON}), the load current feedback signal V_{I-LOAD} generated by the current sense circuit may indicate the real component (e.g., only the real component) of the primary current I_{PRI} (e.g., during the on time T_{ON}).

When the high-side FET Q210 is rendered conductive, the control circuit 150 may drive the signal-chopper control signal V_{CHOP} low towards circuit common to render the transistor Q236 of the current sense circuit 260 non-conductive for a signal-chopper time T_{CHOP}. The signal-chopper time T_{CHOP} may be approximately equal to the on time T_{ON} of the high-side FET Q210, e.g., as shown in FIG. 7. The capacitor C230 may charge from the sense voltage V_{SENSE} through the resistors R232, R234 while the signal-chopper control signal V_{CHOP} is low. The magnitude of the load current feedback signal V_{I-LOAD} may be the average value of the primary current I_{PRI} and may indicate the real component of the primary current during the time when the high-side FET Q210 is conductive. When the high-side FET Q210 is not conductive, the control circuit 150 may drive the signal-chopper control signal V_{CHOP} high to render the transistor Q236 conductive. Accordingly, as described herein, the control circuit 150 may be able to determine the average magnitude of the load current I_{LOAD} from the magnitude of the load current feedback signal V_{I-LOAD}, at least partially because the effects of the magnetizing current I_{MAG} and the oscillations of the primary current I_{PRI} on the magnitude of the load current feedback signal V_{I-LOAD} may be reduced or eliminated.

As the target intensity L_{TRGT} of the LED light source 202 is decreased towards the low-end intensity L_{LE} and/or as the on times T_{ON} of the drive control signals V_{DRIVE1}, V_{DRIVE2} get smaller, the parasitic of the load regulation circuit 140 (e.g., the parasitic capacitances C_{P1}, C_{P2} of the FETs Q210, Q212, the parasitic capacitance C_{P3} of the primary winding of the transformer 220, and/or other parasitic capacitances of the circuit) may cause the magnitude of the primary voltage V_{PRI} to slowly decrease towards zero volts after the FETs Q210, Q212 are rendered non-conductive.

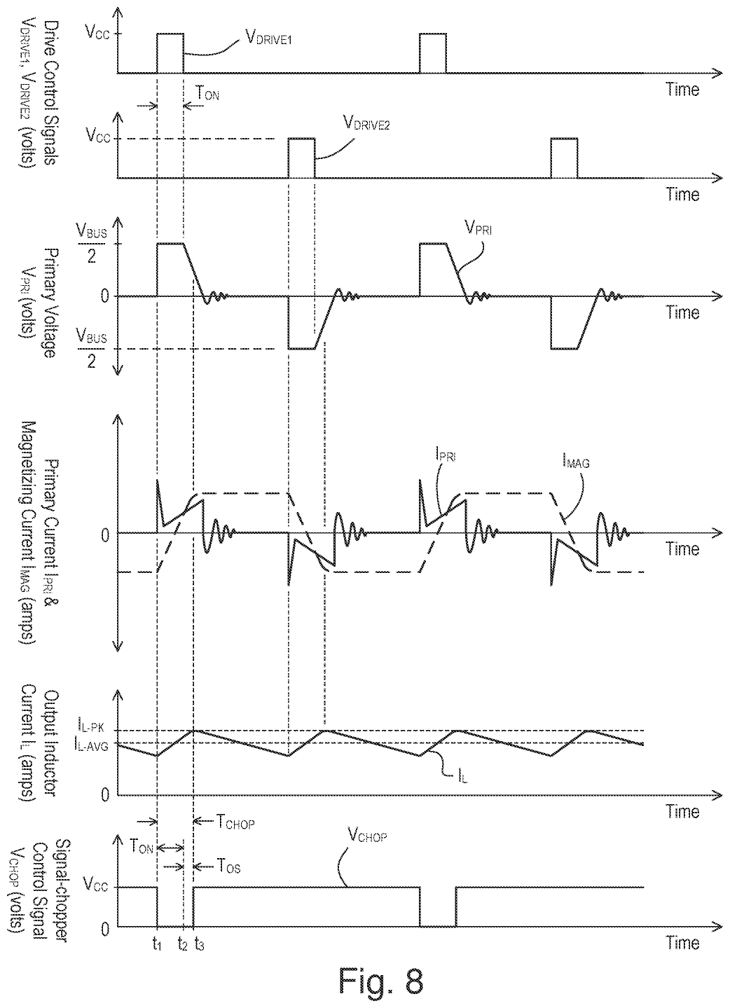

FIG. 8 shows example waveforms illustrating the operation of a forward converter and a current sense circuit (e.g., the forward converter 240 and the current sense circuit 260) when the target intensity L_{TRGT} is near the low-end intensity L_{LE}, and when the forward converter 240 is operating in the normal mode and the active state of the burst mode. The gradual drop off in the magnitude of the primary voltage V_{PRI} may allow the primary winding of the transformer 220 to continue to conduct the primary current I_{PRI}, such that the transformer 220 may continue to deliver power to the secondary winding after the FETs Q210, Q212 are rendered non-conductive, e.g., as shown in FIG. 8. The magnetizing current I_{MAG} may continue to increase in magnitude after the on time T_{ON} of the drive control signal V_{DRIVE1} (e.g., and/or the drive control signal V_{DRIVE2}). The control circuit 150 may increase the signal-chopper time T_{CHOP} to be greater than the on time T_{ON}. For example, the control circuit 150 may increase the signal-chopper time T_{CHOP} (e.g., during which the signal-chopper control signal V_{CHOP} is low) by an offset time T_{OS} when the target intensity L_{TRGT} of the LED light source 202 is near the low-end intensity L_{LE}.

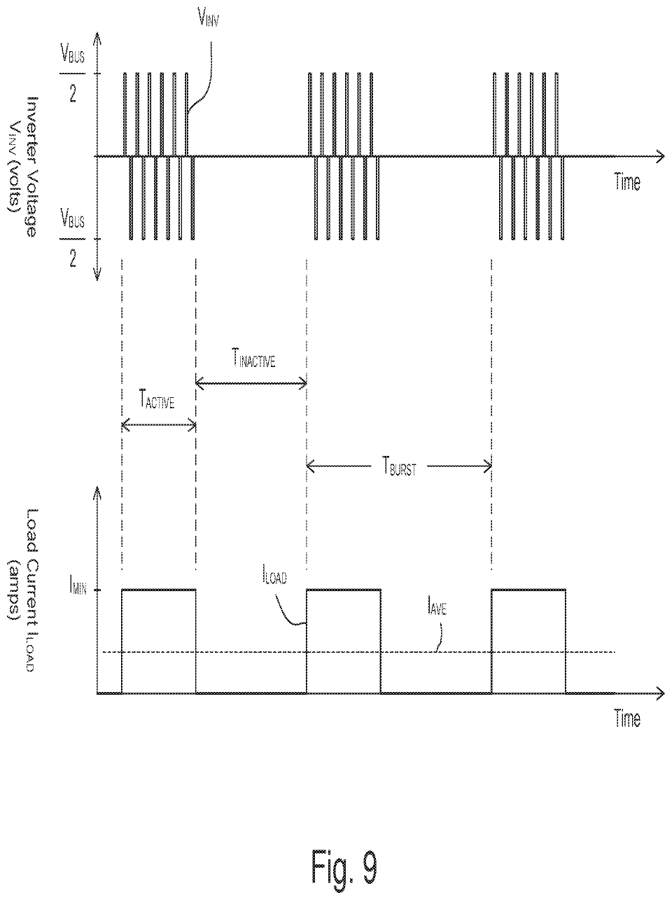

FIG. 9 shows example waveforms illustrating the operation of a forward converter (e.g., the forward converter 240 shown in FIG. 5) during the burst mode. The inverter circuit of the forward converter 240 may be controlled to generate the inverter voltage V_{INV} during an active state (e.g., for an active state period T_{ACTIVE}). A purpose of the inverter voltage V_{INV} may be to regulate the magnitude of the load current I_{LOAD} to the minimum rated current I_{MIN} during the active state period. During the inactive state (e.g., for an inactive state period T_{INACTIVE}), the inverter voltage V_{INV} may be reduced to zero (e.g., not generated). The forward converter may enter the active state on a periodic basis with an interval approximately equal to a burst mode period T_{BURST} (e.g., approximately 4.4 milliseconds). The active state period T_{ACTIVE} and inactive state period T_{INACTIVE} may be characterized by durations that are dependent upon a burst duty cycle DC_{BURST}, e.g., T_{ACTIVE}=DC_{BURST}−T_{BURST} and T_{INACTIVE}=(1−DC_{BURST})−T_{BURST}. The average magnitude I_{AVE} of the load current I_{LOAD} may be dependent on the burst duty cycle DC_{BURST}. For example, the average magnitude I_{AVE} of the load current I_{LOAD} may be equal to the burst duty cycle DC_{BURST} times the load current I_{LOAD} (e.g., I_{AVE}=DC_{BURST}·I_{LOAD}). When the load current I_{LOAD} is equal to the minimum load current I_{MIN}, the average magnitude I_{AVE} of the load current I_{LOAD} may be equal to DC_{BURST}·I_{MIN}.

The burst duty cycle DC_{BURST} may be controlled (e.g., by the control circuit 150) in order to adjust the average magnitude I_{AVE} of the load current I_{LOAD}. The burst duty cycle DC_{BURST} may be controlled in different ways. For example, the burst duty cycle DC_{BURST} may be controlled by holding the burst mode period T_{BURST} constant and varying the length of the active state period T_{ACTIVE}. As another example, the burst duty cycle DC_{BURST} may be controlled by holding the active state period T_{ACTIVE} constant and varying the length of the inactive state period T_{INACTIVE} (and thus the burst mode period T_{BURST}). As the burst duty cycle DC_{BURST} is increased, the average magnitude I_{AVE} of the load current I_{LOAD} may increase. As the burst duty cycle DC_{BURST} is decreased, the average magnitude I_{AVE} of the load current I_{LOAD} may decrease. In an example, the burst duty cycle DC_{BURST} may be adjusted via open loop control (e.g., in response to the target intensity L_{TRGT}). In another example, the burst duty cycle DC_{BURST} may be adjusted via closed loop control (e.g., in response to the load current feedback signal V_{I-LOAD}).

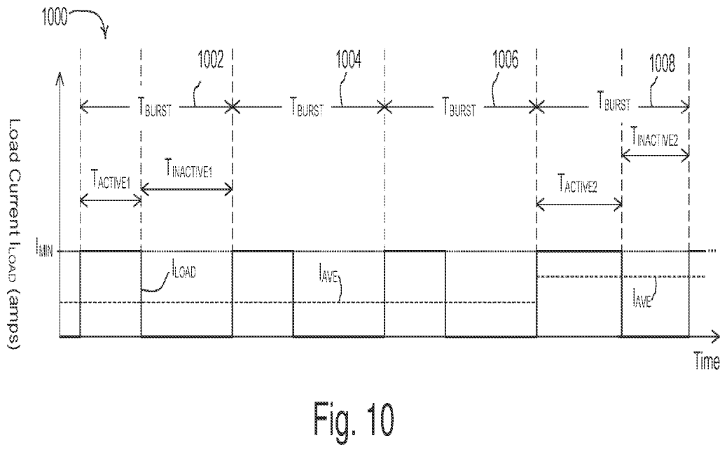

FIG. 10 shows a diagram of an example waveform 1000 illustrating the load current I_{LOAD} when a load regulation circuit (e.g., the load regulation circuit 140) operates in the burst mode. The active state period T_{ACTIVE} of the load current I_{LOAD} may have a length that is dependent upon the length of an inverter cycle of the inverter circuit (e.g., the operating period T_{OP}). For example, referring back to FIG. 9, the active state period T_{ACTIVE} may comprise six inverter cycles, and as such, has a length that is equal to the duration of the six inverter cycles. A control circuit (e.g., the control circuit 150 of the LED driver 100 shown in FIG. 1 and/or the control circuit 150 show in FIG. 5) may adjust (e.g., increase or decrease) the active state periods T_{ACTIVE} by adjusting the number of inverter cycles in the active state period T_{ACTIVE}. As such, the control circuit may be operable to adjust the active state periods T_{ACTIVE} by specific increments/decrements (e.g., the values of which may be predetermined), with each increment/decrement equal to approximately one inverter cycle (e.g., such as the low-end operating period T_{OP-LE}, which may be approximately 12.8 microseconds). Since the average magnitude I_{AVE} of the load current I_{LOAD} may depend upon the active state period T_{ACTIVE}, the average magnitude I_{AVE} may be adjusted by an increment/decrement (e.g., the value of which may be predetermined) that corresponds to a change in load current I_{LOAD} resulting from the addition or removal of one inverter cycle per active state period T_{ACTIVE}.

FIG. 10 shows four example burst mode periods T_{BURST} 1002, 1004, 1006, 1008 with equivalent lengths. The first three burst mode periods 1002, 1004, 1006 may be characterized by equivalent active state periods T_{ACTIVE1} (e.g., with a same number of inverter cycles) and equivalent inactive state periods T_{INACTIVE1}. The fourth burst mode periods T_{BURST} 1008 may be characterized by an active state period T_{ACTIVE2} that is larger than the active state period T_{ACTIVE1} (e.g., by an additional inverter cycle) and an inactive state period T_{INACTIVE2} that is smaller than the inactive state period T_{INACTIVE1} (e.g., by one fewer inverter cycle). The larger active state period T_{ACTIVE2} and smaller inactive state period T_{INACTIVE2} may result in a larger duty cycle and a corresponding larger average magnitude I_{AVE} of the load current I_{LOAD} (e.g., as shown during burst mode period 1008). As the average magnitude I_{AVE} of the load current I_{LOAD} increases, the intensity of the light source may increase accordingly. Hence, as shown in FIG. 10, by adding inverter cycles to or removing inverter cycles from the active state periods T_{ACTIVE} while maintaining the length of the burst mode periods T_{BURST}, the control circuit may be operable to adjust the average magnitude I_{AVE} of the load current I_{LOAD}. Such adjustments to only the active state periods T_{ACTIVE}, however, may cause changes in the intensity of the lighting load that are perceptible to the user, e.g., when the target intensity is equal to or below the low-end intensity L_{LE} (e.g., 5% of a rated peak intensity).

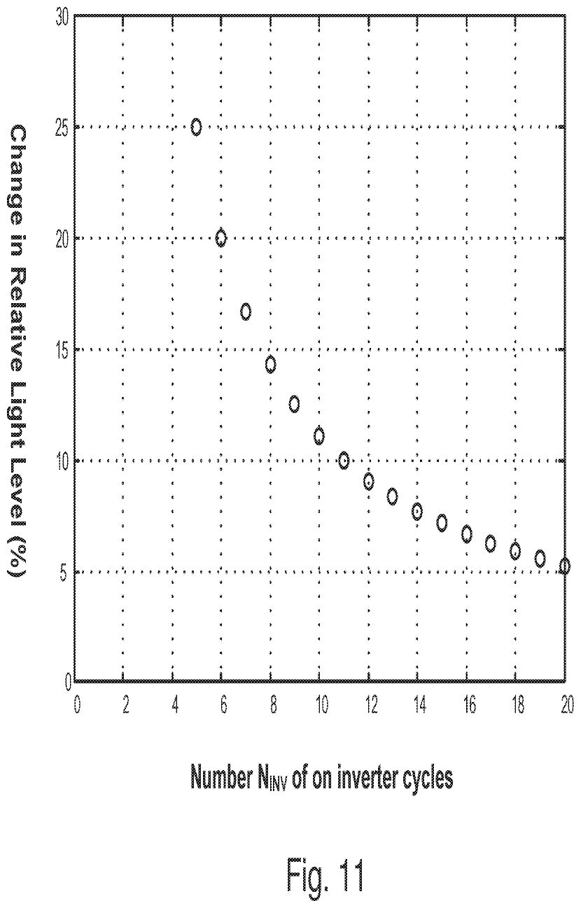

FIG. 11 illustrates how the average light intensity of a light source may change as a function of the number N_{INV} of inverter cycles included in an active state period T_{ACTIVE} if the control circuit only adjusts the active state period T_{ACTIVE} during the burst mode. As described herein, the active state period T_{ACTIVE} may be expressed as T_{ACTIVE}=N_{INV}·T_{OP-LE}, wherein T_{OP-LE} may represent a low-end operating period of the relevant inverter circuit. As shown in FIG. 11, if the control circuit adjusts the length of the active state period T_{ACTIVE} from four to five inverter cycles, the relative light level may change by approximately 25%. If the control circuit adjusts the length of the active state period T_{ACTIVE} from five to six inverter cycles, the relative light level may change by approximately 20%.

Fine tuning of the intensity of a lighting load while operating in the burst mode may be achieved by configuring the control circuit to apply different control techniques to the load regulation circuit. For example, the control circuit may be configured to apply a specific control technique based on the target intensity. As described herein, the control circuit may enter the burst mode of operation if the target intensity is equal to or below the transition intensity L_{TRAN} (e.g., approximately 5% of a rated peak intensity). Within this low-end intensity range (e.g., from approximately 1% to 5% of the rated peak intensity), the control circuit may be configured to operate in at least two different modes. A low-end mode may be entered when the target intensity is within the lower portion of the low-end intensity range, e.g., between approximately 1% and 4% of the rated peak intensity. An intermediate mode may be entered when the target intensity is within the higher portion of the low-end intensity range, e.g., from approximately 4% of the rated peak intensity to the transition intensity L_{TRAN} or just below the transition intensity L_{TRAN} (e.g., approximately 5% of the rated peak intensity).

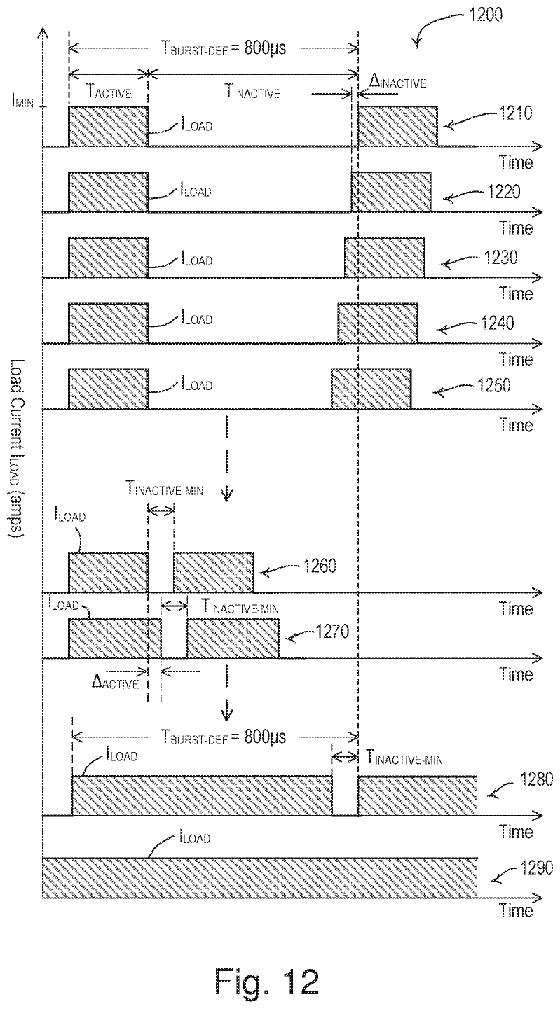

FIG. 12 shows example waveforms illustrating a load current when a control circuit (e.g., the control circuit 150) is operating in a burst mode. For example, as shown in FIG. 12, the target intensity L_{TRGT} of the light source (e.g., the LED light source 202) may increase from approximately the low-end intensity L_{LE} to the transition intensity L_{TRAN} from one waveform to the next moving down the sheet from the top to the bottom. The control circuit may control the load current I_{LOAD} over one or more default burst mode periods T_{BURST-DEF}. The default burst mode period T_{BURST-DEF} may, for example, have a value of approximately 800 microseconds to correspond to a frequency of approximately 1.25 kHz. The inverter circuit of the load regulation circuit may be characterized by an operating frequency f_{OP-BURST} (e.g., approximately 25 kHz) and an operating period T_{OP-BURST} (e.g., approximately 40 microseconds).

The control circuit may enter the low-end mode of operation when the target intensity L_{TRGT} of the light source is between a first value (e.g., the low-end intensity L_{LE}, which may be approximately 1% of the rated peak intensity) and a second value (e.g., approximately 4% of a rated peak intensity). In the low-end mode, the control circuit may be configured to adjust the average magnitude I_{AVE} of the load current I_{LOAD} (and thereby the intensity of the light source) by adjusting the length of the inactive state periods T_{INACTIVE} while keeping the length of the active state periods T_{ACTIVE} constant. For example, to increase the average magnitude I_{AVE}, the control circuit may keep the length of the active state periods T_{ACTIVE} constant and decrease the length of the inactive state periods T_{INACTIVE}; to decrease the average magnitude I_{AVE}, the control circuit may keep the length of the active state periods T_{ACTIVE} Constant and increase the length of the inactive state periods T_{INACTIVE}.

The control circuit may adjust the length of the inactive state period T_{INACTIVE} in one or more steps. For example, the control circuit may adjust the length of the inactive state period T_{INACTIVE} by an inactive-state adjustment amount Δ_{INACTIVE} at a time. The inactive-state adjustment amount Δ_{INACTIVE} may have a value (e.g., a predetermined value) that is, for example, a percentage (e.g., approximately 1%) of the default burst mode period T_{BURST-DEF} or in proportion to the length of a timer tick (e.g., a tick of a timer comprised in the control device). Other values for the inactive-state adjustment amount Δ_{INACTIVE} may also be possible, so long as they may allow fine tuning of the intensity of the light source. The value of the inactive-state adjustment amount Δ_{INACTIVE} may be stored in a storage device (e.g., a memory). The storage device may be coupled to the control device and/or accessible to the control device. The value of the inactive-state adjustment amount Δ_{INACTIVE} may be set during a configuration process of the load control system. The value may be modified, for example, via a user interface.

The control circuit may adjust the length of the inactive state periods T_{INACTIVE} as a function of the target intensity L_{TRGT} (e.g., using open loop control). For example, given a target intensity L_{TRGT}, the control circuit may determine an amount of adjustment to apply to the inactive state period T_{INACTIVE} in order to bring the intensity of the light source to the target intensity. The control circuit may determine the amount of adjustment in various ways, e.g., by calculating the value in real-time and/or by retrieving the value from memory (e.g., via a lookup table or the like). The control circuit may be configured to adjust the length of the inactive state periods T_{INACTIVE} by the inactive-state adjustment amount Δ_{INACTIVE} one step at a time (e.g., in multiple steps) until the target intensity is achieved.

The control circuit may adjust the length of the inactive state periods T_{INACTIVE} to achieve a target intensity L_{TRGT} based on a current feedback signal (e.g., using closed loop control). For example, given the target intensity L_{TRGT}, the control circuit may be configured to adjust the length of the inactive state periods T_{INACTIVE} initially by the inactive-state adjustment amount Δ_{INACTIVE}. The control circuit may then wait for a load current feedback signal V_{I-LOAD} from a current sense circuit (e.g., the current sense circuit 160). The load current feedback signal V_{I-LOAD} may indicate the average magnitude I_{AVE} of the load current I_{LOAD} and thereby the intensity of the light source. The control circuit may compare the indicated intensity of the light source with the target intensity to determine whether additional adjustments of the inactive state periods T_{INACTIVE} are necessary. The control circuit may make multiple stepped adjustments to achieve the target intensity. The step size may be equal to approximately the inactive-state adjustment amount Δ_{INACTIVE}.

Waveforms 1210-1260 in FIG. 12 illustrate the example control technique that may be applied in the low-end mode (e.g., as target intensity L_{TRGT} is increasing from waveform 1210 to waveform 1260). As shown in the waveform 1210, the load current I_{LOAD} may have a burst mode period T_{BURST-DEF} (e.g., approximately 800 microseconds corresponding to a frequency of approximately 1.25 kHz) and a burst duty cycle. The burst duty cycle may be 20%, for example, to correspond to a light intensity of 1% of the rated peak intensity. The inactive state periods T_{INACTIVE} corresponding to the burst mode period T_{BURST-DEF} and the burst duty cycle may be denoted herein as T_{INACTIVE-MAX}. In the waveform 1220, the length of the inactive state periods T_{INACTIVE} of the load current I_{LOAD} is decreased by the inactive-state adjustment amount Δ_{INACTIVE} while the length of the active state periods T_{ACTIVE} is maintained in order to adjust the intensity of the light source toward a higher target intensity. The decrease may continue in steps, e.g., as shown in the waveforms 1230 to 1260, by the inactive-state adjustment amount Δ_{INACTIVE} in each step until the target intensity is achieved or a minimum inactive state period T_{INACTIVE-MIN} is reached (e.g., as shown in waveform 1260). The minimum inactive state period T_{INACTIVE-MIN} may be determined based on the configuration and/or limitations of one or more hardware components of the relevant circuitry. For example, as the inactive state periods T_{INACTIVE} decrease, the operating frequency of the burst mode may increase. When the operating frequency reaches a certain level, the outputs of some hardware components (e.g., the output current of the inductor L226 of the forward converter 240, as shown in FIG. 5) at the tail of one burst cycle may begin to interfere with the outputs at the start of the next burst cycle. Accordingly, in the example described herein, the minimum inactive state period T_{INACTIVE-MIN} may be set to a minimum value at which the component outputs during consecutive burst cycles would not interfere with each other. In at least some cases, such a minimum value may correspond to a burst duty cycle of approximately 80% and to a target intensity value at which the control circuit may enter the intermediate mode of operation.

Once the length of the inactive state periods T_{INACTIVE} has reached the minimum inactive state period T_{INACTIVE-MIN}, the control circuit may be configured to transition into the intermediate mode of operation described herein. In certain embodiments, the transition may occur when the target intensity is at a specific value (e.g., approximately 4% of the rated peak intensity). While in the intermediate mode, the control circuit may be configured to adjust the average magnitude I_{AVE} of the load current I_{LOAD} by adjusting the length of the active state period T_{ACTIVE} and keeping the length of the inactive state periods T_{INACTIVE} constant (e.g., at the minimum inactive state period T_{INACTIVE-MIN}). The adjustments to the active state periods may be made gradually, e.g., by an active-state adjustment amount Δ_{ACTIVE} in each increment/decrement (e.g., as shown in waveform 1270 in FIG. 12). In certain embodiments, the active-state adjustment amount Δ_{ACTIVE} may be approximately equal to one inverter cycle length.

The control circuit may adjust the length of the active state periods T_{ACTIVE} as a function of the target intensity L_{TRGT} (e.g., using open loop control). For example, given a target intensity L_{TRGT}, the control circuit may determine an amount of adjustment to apply to the active state period T_{INACTIVE} in order to bring the intensity of the light source to the target intensity. The control circuit may determine the amount of adjustment in various ways, e.g., by calculating the value in real-time and/or by retrieving the value from memory (e.g., via a lookup table or the like). The control circuit may be configured to adjust the length of the active state periods T_{ACTIVE} by the active-state adjustment amount Δ_{ACTIVE} one step at a time (e.g., in multiple steps) until the total amount of adjustment is achieved.

The control circuit may adjust the length of the active state periods T_{ACTIVE} to achieve a target intensity L_{TRGT} based on a current feedback signal (e.g., using closed loop control). For example, given the target intensity L_{TRGT}, the control circuit may be configured to adjust the length of the active state periods T_{ACTIVE} initially by the active-state adjustment amount Δ_{ACTIVE}. The control circuit may then wait for a load current feedback signal V_{I-LOAD} from a current sense circuit (e.g., the current sense circuit 160). The load current feedback signal V_{I-LOAD} may indicate the average magnitude I_{AVE} of the load current I_{LOAD} and thereby the intensity of the light source. The control circuit may compare the indicated intensity of the light source with the target intensity to determine whether additional adjustments of the active state periods T_{ACTIVE} are necessary. The control circuit may make multiple adjustments to achieve the target intensity. For example, the adjustments may be made in multiple steps, with a step size equal to approximately the active-state adjustment amount Δ_{ACTIVE}.

As the target intensity increases in the intermediate mode of operation, the control circuit may eventually adjust the burst mode period back to the initial burst mode period T_{BURST-DEF} (e.g., as shown in waveform 1280 in FIG. 12). At that point, the burst duty cycle in certain embodiments may be approximately 95% and the length of the active state periods (denoted herein as T_{ACTIVE-95% DC}) in those embodiments may be equal to approximately the difference between the initial burst mode period T_{BURST-DEF} and the present length of the inactive state period T_{INACTIVE} (e.g., the minimum inactive state period T_{INACTIVE-MIN}). To further increase the intensity of the light source until the control circuit enters the normal mode of operation (e.g., at approximately 5% of the rated peak intensity and/or 100% burst duty cycle, as shown in waveform 1290), the control circuit may be configured to apply other control techniques including, for example, a dithering technique. Since the transition is over a relatively small range (e.g., from a 95% duty cycle at the end of the intermediate mode to a 100% duty cycle at the beginning of the normal mode), it may be made with minimally visible changes in the intensity of the lighting load.

FIG. 13 shows two example plot relationships between a target intensity of the lighting load and the respective lengths of the active and inactive state periods. Both plots depict situations that may occur during one or more of the modes of operation described herein. For example, the plot 1300 shows an example plot relationship between the length of the inactive state periods T_{INACTIVE} and the target intensity L_{TRGT} of the light source. As another example, the plot 1310 shows an example plot relationship between the length of the active state periods T_{ACTIVE} and the target intensity L_{TRGT} of the light source. In the illustrated example, the length of the active state periods T_{ACTIVE} may be expressed either in terms of time or in terms of the number of inverter cycles N_{INV} included in the active state period T_{ACTIVE}.

As described herein, the control circuit (e.g., the control circuit 150) may determine the magnitude of the target load current I_{TRGT} and/or the burst duty cycle DC_{BURST} during the burst mode based on a target intensity L_{TRGT}. The control circuit may receive the target intensity L_{TRGT}, for example, via a digital message transmitted through a communication circuit (e.g., the communication circuit 180), via a phase-control signal from a dimmer switch, and/or the like. The control circuit may determine the length of the active state periods T_{ACTIVE} and the length of the inactive state periods T_{INACTIVE} such that the intensity of the light source may be driven to the target intensity L_{TRGT}. The control circuit may determine the lengths of the active state periods T_{ACTIVE} and the inactive state periods T_{INACTIVE}, for example, by calculating the values in real-time or by retrieving the values from memory (e.g., via a lookup table or the like).

Referring to FIG. 13, if the control circuit determines that the target intensity L_{TRGT} falls within a range 1321, the control circuit may operate in the low-end mode and may set the active state period T_{ACTIVE} to a minimum active state period T_{ACTIVE-MIN} (e.g., including four inverter cycles and/or corresponding to a 20% burst duty cycle). Near the low-end intensity L_{LE} (e.g., approximately 1%), the control circuit may set the burst mode period to a default burst mode period (e.g., such as the default burst mode period T_{BURST-DEF}, which may be approximately 800 microseconds). The control circuit may set the inactive state period T_{INACTIVE} according to a profile 1341, which may range from a maximum inactive state period T_{INACTIVE-MAX} to a minimum inactive state period T_{INACTIVE-MIN}. The maximum inactive state period T_{INACTIVE-MAX} may be equal to the difference between the default burst mode period and the minimum active state period T_{ACTIVE-MIN}, and/or may correspond to a low-end duty cycle of 20%. The minimum inactive state period T_{INACTIVE-MIN} may depend on hardware configuration and/or limitations of the relevant circuitry, as described herein. The gradient (e.g., rate of change) of the profile 1341 may be determined based on an inactive-state adjustment amount (e.g., such as the inactive-state adjustment amount Δ_{INACTIVE}), which may in turn be determined as a function of (e.g., in proportion to) the length of a timer tick (e.g., a timer comprised in the control device) or a percentage (e.g., approximately 1%) of the default burst mode period T_{BURST-DEF}, for example. As noted, the control circuit may determine the lengths of the active state period T_{ACTIVE} and/or the inactive state period T_{INACTIVE} by calculating the values in real-time and/or retrieving the values from memory.

If the control circuit determines that the target intensity L_{TRGT} falls within a range 1322, the control circuit may operate in the intermediate mode and may set the inactive state period T_{INACTIVE} to the minimum inactive state period (e.g., such as the minimum inactive state period T_{INACTIVE-MIN}). The control circuit may set the active state period T_{ACTIVE} according to a profile 1342. The profile 1342 may have a minimum value, which may be the minimum active state period T_{ACTIVE-MIN}. The profile 1342 may have a maximum value T_{ACTIVE-95% DC}, which may correspond to the active state period T_{ACTIVE} when the burst mode period has been adjusted back to the default burst mode period T_{BURST-DEF} and the inactive state period T_{INACTIVE} is at the minimum inactive state period T_{INACTIVE-MIN}. In at least some examples, the maximum value for the active state period T_{ACTIVE} may correspond to a burst duty cycle of 95%. The gradient (e.g., the rate of change) of the profile 1342 may be determined based on an active-state adjustment amount Δ_{ACTIVE}. As described herein, the active-state adjustment amount Δ_{ACTIVE} may be equal to the length of one inverter cycle.

If the control circuit determines that the target intensity L_{TRGT} falls within the range 1323, the control circuit may utilize other control techniques (e.g., such as dithering) to transition the load regulation circuit into a normal mode of operation. Although the active state period T_{ACTIVE} and inactive state period T_{INACTIVE} are depicted in FIG. 13 as being unchanged during the transition (e.g., from a 95% duty cycle to a 100% duty cycle), a person skilled in the art will appreciate that the profiles of the active and inactive periods may be different than depicted in FIG. 13 depending on the specific control technique applied. The normal mode of operation may occur during the range 1324 (e.g., from approximately 5% to 100% of the rated peak intensity). During the normal mode of operation, the length of the inactive state period may be reduced to near zero and the burst duty cycle may be increased to approximately 100%.

The profiles 1341, 1342 may be linear or non-linear, and may be continuous (e.g., as shown in FIG. 13) or comprise discrete steps. The inactive-state adjustment amount Δ_{INACTIVE} and/or the active-state adjustment amount Δ_{ACTIVE} may be sized to reduce visible changes in the relative light level of the lighting load. The transition points (e.g., in terms of a target intensity) at which the control circuit may switch from one mode of operation to another are illustrative and may vary in implementations, for example, based on the hardware used and/or the standard being followed.

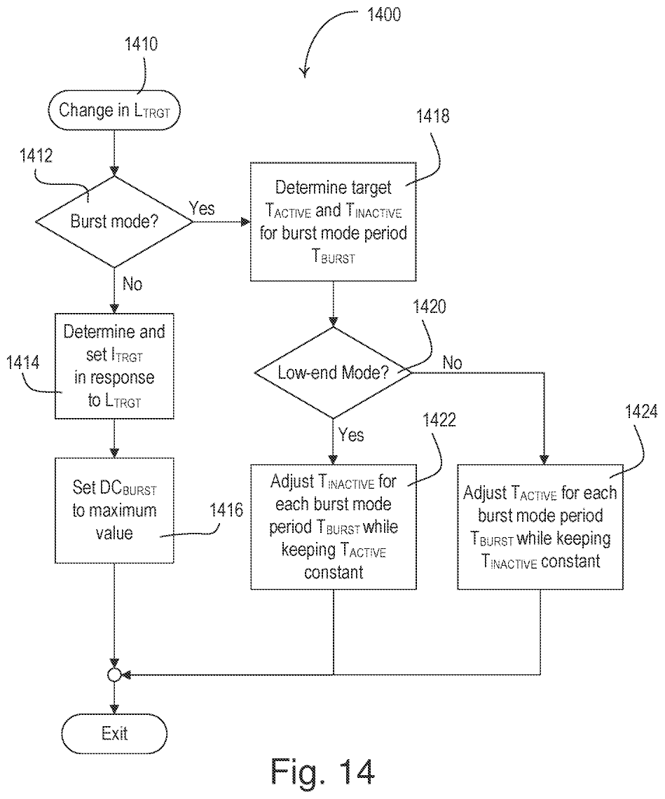

FIG. 14 shows a simplified flowchart of an example light intensity control procedure 1400 that may be executed by a control circuit (e.g., the control circuit 150). The light intensity control procedure 1400 may be started, for example, when a target intensity L_{TRGT} of the lighting load is changed at 1410 (e.g., via digital messages received through the communication circuit 180). At 1412, the control circuit may determine whether it should operate in the burst mode (e.g., the target intensity L_{TRGT} is between the low-end intensity L_{LE} and the transition intensity L_{TRAN}, i.e., L_{LE}≤L_{TRGT}≤L_{TRAN}). If the control circuit determines that it should not be in the burst mode (e.g., but rather in the normal mode), the control circuit may, at 1414, determine and set the target load current I_{TRGT} as a function of the target intensity L_{TRGT} (e.g., as shown in FIG. 2). At 1416, the control circuit may set the burst duty cycle DC_{BURST} equal to a maximum duty cycle DC_{MAX} (e.g., approximately 100%) (e.g., as shown in FIG. 3), and the control circuit may exit the light intensity control procedure 1400.

If, at 1412, the control circuit determines that it should enter the burst mode (e.g., the target intensity L_{TRGT} is below the transition intensity L_{TRAN} or L_{TRGT}<L_{TRAN}), the control circuit may determine, at 1418, target lengths of the active state periods T_{ACTIVE} and/or the inactive state periods T_{INACTIVE} for one or more burst mode periods T_{BURST}. The control circuit may determine the target lengths of the active state periods T_{ACTIVE} and/or the inactive state periods T_{INACTIVE}, for example, by calculating the values in real-time and/or retrieving the values from memory (e.g., via a lookup table or the like). At 1420, the control circuit may determine whether it should operate in the low-end mode of operation. If the determination is to operate in the low-end mode, the control circuit may, at 1422, adjust the length of the inactive state periods T_{INACTIVE} for each of the plurality of burst mode periods T_{BURST} while keeping the length of the active state periods constant. The control circuit may make multiple adjustments (e.g., with equal amount of adjustment each time) to the inactive state periods T_{INACTIVE} until the target length of the inactive state periods T_{INACTIVE} is reached. The control circuit may then exit the light intensity control procedure 1400.

If the determination at 1420 is to not operate in the low-end mode (but rather in the intermediate mode), the control circuit may, at 1424, adjust the length of the active state periods T_{ACTIVE} for each of the plurality of burst mode periods T_{BURST} while keeping the length of the inactive state periods constant. The control circuit may make multiple adjustments (e.g., with equal amount of adjustment each time) to the active state periods T_{ACTIVE} until the target length of the active state periods T_{ACTIVE} is reached. The control circuit may then exit the light intensity control procedure 1400.

As described herein, the control circuit may adjust the active state periods T_{ACTIVE} and/or the inactive state periods T_{INACTIVE} as a function of the target intensity L_{TRGT} (e.g., using open loop control). The control circuit may adjust the active state periods T_{ACTIVE} and/or the inactive state periods T_{INACTIVE} in response to a load current feedback signal V_{I-LOAD} (e.g., using closed loop control).

As described herein, during the active state periods of the burst mode, the control circuit may be configured to adjust the on time T_{ON} of the drive control signals V_{DRIVE1}, V_{DRIVE2} to control the peak magnitude I_{PK} of the load current I_{LOAD} to the minimum rated current I_{MIN} using closed loop control (e.g., in response to the load current feedback signal V_{I-LOAD}). The value of the low-end operating frequency f_{OP} may be selected to ensure that the control circuit does not adjust the on time T_{ON} of the drive control signals V_{DRIVE1}, V_{DRIVE2} below the minimum on time T_{ON-MIN}. For example, the low-end operating frequency f_{OP} may be calculated by assuming worst case operating conditions and component tolerances and stored in memory in the LED driver. Since the LED driver may be configured to drive a plurality of different LED light sources (e.g., manufactured by a plurality of different manufacturers) and/or adjust the magnitude of the load current I_{LOAD} and the magnitude of the load voltage V_{LOAD} to a plurality of different magnitudes, the value of the on time T_{ON} during the active state of the burst mode may be much greater than the minimum on time T_{ON-MIN} for many installations. If the value of the on time T_{ON} during the active state of the burst mode is too large, steps in the intensity of the LED light source may be visible to a user when the target intensity L_{TRGT} is adjusted near the low-end intensity (e.g., during the burst mode).

One or more of the embodiments described herein (e.g., as performed by a load control device) may be used to decrease the intensity of a lighting load and/or increase the intensity of the lighting load. For example, one or more embodiments described herein may be used to adjust the intensity of the lighting load from on to off, off to on, from a higher intensity to a lower intensity, and/or from a lower intensity to a higher intensity. For example, one or more of the embodiments described herein (e.g., as performed by a load control device) may be used to fade the intensity of a light source from on to off (i.e., the low-end intensity L_{LE} may be equal to 0%) and/or to fade the intensity of the light source from off to on.

Although described with reference to an LED driver, one or more embodiments described herein may be used with other load control devices. For example, one or more of the embodiments described herein may be performed by a variety of load control devices that are configured to control of a variety of electrical load types, such as, for example, a LED driver for driving an LED light source (e.g., an LED light engine); a screw-in luminaire including a dimmer circuit and an incandescent or halogen lamp; a screw-in luminaire including a ballast and a compact fluorescent lamp; a screw-in luminaire including an LED driver and an LED light source; a dimming circuit for controlling the intensity of an incandescent lamp, a halogen lamp, an electronic low-voltage lighting load, a magnetic low-voltage lighting load, or another type of lighting load; an electronic switch, controllable circuit breaker, or other switching device for turning electrical loads or appliances on and off; a plug-in load control device, controllable electrical receptacle, or controllable power strip for controlling one or more plug-in electrical loads (e.g., coffee pots, space heaters, other home appliances, and the like); a motor control unit for controlling a motor load (e.g., a ceiling fan or an exhaust fan); a drive unit for controlling a motorized window treatment or a projection screen; motorized interior or exterior shutters; a thermostat for a heating and/or cooling system; a temperature control device for controlling a heating, ventilation, and air conditioning (HVAC) system; an air conditioner; a compressor; an electric baseboard heater controller; a controllable damper; a humidity control unit; a dehumidifier; a water heater; a pool pump; a refrigerator; a freezer; a television or computer monitor; a power supply; an audio system or amplifier; a generator; an electric charger, such as an electric vehicle charger; and an alternative energy controller (e.g., a solar, wind, or thermal energy controller). A single control circuit may be coupled to and/or adapted to control multiple types of electrical loads in a load control system.

What is claimed is:

1. A lighting control apparatus comprising:
load regulation circuitry that includes inverter circuitry; and
control circuitry operatively coupled to the load regulation circuit, the control circuitry to, responsive to receipt of an input that includes data representative of a target intensity:
determine whether the received target intensity is greater than a defined threshold intensity value; and
responsive to the determination that the target intensity is greater than the defined threshold intensity value, cause the load regulation circuitry to operate in a first operating mode in which the duty cycle of the load regulation circuit is held constant and target current is varied to achieve a defined load current that corresponds to the target intensity; and
responsive to the determining that the target intensity is not greater than the defined threshold intensity value, cause the load regulation circuitry to operate in a second operating mode in which the target current is held constant and a duty cycle of the inverter circuitry is varied to achieve the load current that corresponds to the target intensity.

2. The lighting control apparatus of claim 1 wherein to determine whether the received target intensity is greater than the defined threshold intensity value, the control circuitry to further:
determine whether the received target intensity is greater than an intensity value corresponding to a minimum load current of an operatively coupled lighting load.

3. The lighting control apparatus of claim 1 wherein to cause the load regulation circuitry to operate in the second operating mode, the control circuitry to further:
determine whether the received data representative of the target intensity is in a first intensity range that is less than the defined threshold intensity value; and
responsive to receipt of the data representative of the target intensity in the first intensity range, cause the inverter circuitry to operate in a first burst mode having an active state period in which the inverter circuitry is active and an inactive state period in which the inverter circuitry is inactive;
wherein in the first burst mode, the control circuitry holds the active state period constant and varies the inactive state period to provide the load current that corresponds to the target intensity.

4. The lighting control apparatus of claim 3 wherein to cause the load regulation circuitry to operate in the second operating mode, the control circuitry to further:
determine whether the received data representative of the target intensity is in a second intensity range that between the first intensity range and the defined threshold intensity value; and
cause the inverter circuitry to operate in a second burst mode responsive to the determination that the received target intensity is in the second intensity range;
wherein in the second burst mode, the control circuitry holds the inactive state period constant and varies the active state period to provide the load current that corresponds to the target intensity.

5. The lighting control apparatus of claim 1 wherein to determine whether the received target intensity is greater than the defined threshold intensity value that corresponds to a minimum load current of an operatively coupled lighting load, the control circuitry to further:
retrieve from operatively coupled memory circuitry, data representative of a low-end intensity of the operatively coupled lighting load that corresponds to a low-end trim value; and
compare the received target intensity to the retrieved low-end intensity to determine whether the received target intensity is greater than the defined threshold intensity value.

6. A lighting control method, comprising:
receiving, by lighting control circuitry, an input that includes data representative of a target intensity of an operatively coupled lighting load;
determining, by the lighting control circuitry, whether the received target intensity is greater than a defined threshold intensity value; and
causing, by the lighting control circuitry responsive to the determination that the received target intensity is greater than the defined threshold intensity value, operatively coupled load regulation circuitry to operate in a first operating mode in which the duty cycle of the load regulation circuitry is held constant and target current is varied to achieve a defined load current that corresponds to the received target intensity; and
causing, by the lighting control circuitry responsive to the determination that the target intensity is not greater than the defined threshold intensity value, the load regulation circuitry to operate in a second operating mode in which the target current is held constant and a duty cycle of inverter circuitry included in the load regulation circuitry is varied to achieve the load current that corresponds to the target intensity.

7. The method of claim 6 wherein determining whether the received target intensity is greater than the defined threshold intensity value further comprises:
determining, by the lighting control circuitry, whether the received target intensity is greater than an intensity value corresponding to a minimum load current of an operatively coupled lighting load.

8. The method of claim 6 wherein causing the load regulation circuitry to operate in the second operating mode further comprises:
determining, by the lighting control circuitry, whether the received data representative of the target intensity is in a first intensity range that is less than the defined threshold intensity value; and
causing, by the lighting control circuitry, the inverter circuitry to operate in a first burst mode having an active state period in which the inverter circuitry is active and an inactive state period in which the inverter circuitry is inactive responsive to receipt of the data representative of the target intensity in the first intensity range;
wherein in the first burst mode, the control circuitry holds the active state period constant and varies the inactive state period to provide the load current that corresponds to the target intensity.

9. The method of claim 8 wherein causing the load regulation circuitry to operate in the second operating mode further comprises:
determining, by the lighting control circuitry, whether the received data representative of the target intensity is in a second intensity range that between the first intensity range and the defined threshold intensity value; and
causing, by the lighting control circuitry, the inverter circuitry to operate in a second burst mode responsive to the determination that the received target intensity is in the second intensity range;
wherein in the second burst mode, the control circuitry holds the inactive state period constant and varies the active state period to provide the load current that corresponds to the target intensity.

10. The method of claim 6 wherein determining whether the received target intensity is greater than the defined threshold intensity value that corresponds to a minimum load current of an operatively coupled lighting load further comprises:
retrieving, by the lighting control circuitry, from operatively coupled memory circuitry, data representative of a low-end intensity of the operatively coupled lighting load that corresponds to a low-end trim value; and
comparing, by the lighting control circuitry, the received target intensity to the retrieved low-end intensity to determine whether the received target intensity is greater than the defined threshold intensity value.

11. A non-transitory, machine-readable, storage device that includes instructions that, when executed by lighting control circuitry operatively coupled to load regulation circuitry, cause the lighting control circuitry to:
receive an input that includes data representative of a target intensity of an operatively coupled lighting load;
determine whether the received target intensity is greater than a defined threshold intensity value that corresponds to a minimum load current of an operatively coupled lighting load; and
cause the load regulation circuitry to operate in a first operating mode in which the duty cycle of the load regulation circuitry is held constant and target current is varied to achieve a defined load current that corresponds to the received target intensity responsive to the determination by the lighting control circuitry that the received target intensity is greater than the defined threshold intensity value; and
cause the load regulation circuitry to operate in a second operating mode in which the target current is held constant and a duty cycle of inverter circuitry included in the load regulation circuitry is varied to achieve the load current that corresponds to the target intensity responsive to the determination that the target intensity is not greater than the defined threshold intensity value.

12. The non-transitory, machine-readable, storage device of claim 11 wherein the instructions that cause the lighting control circuitry to determine whether the received target intensity is greater than the defined threshold intensity value further cause the lighting control circuitry to:
determine whether the received target intensity is greater than the defined threshold intensity value, wherein the defined threshold intensity value corresponds to a minimum load current of the lighting load.

13. The non-transitory, machine-readable, storage device of claim 11 wherein the instructions that cause the lighting control circuitry to cause the load regulation circuitry to operate in the second operating mode further cause the lighting control circuitry to:
determine whether the received data representative of the target intensity is in a first intensity range that is less than the defined threshold intensity value; and
cause inverter circuitry included in the load regulation circuitry to operate in a first burst mode having an active state period in which the inverter circuitry is active and an inactive state period in which the inverter circuitry is inactive responsive to receipt of the data representative of the target intensity in the first intensity range;
wherein in the first burst mode, the control circuitry holds the active state period constant and varies the inactive state period to provide the load current that corresponds to the target intensity.

14. The non-transitory, machine-readable, storage device of claim 13 wherein the instructions that cause the lighting control circuitry to cause the load regulation circuitry to operate in the second operating mode further cause the lighting control circuitry to:
determine whether the received data representative of the target intensity is in a second intensity range that between the first intensity range and the defined threshold intensity value; and
causing, by the lighting control circuitry, the inverter circuitry to operate in a second burst mode responsive to the determination that the received target intensity is in the second intensity range;
wherein in the second burst mode, the control circuitry holds the inactive state period constant and varies the active state period to provide the load current that corresponds to the target intensity.

15. The non-transitory, machine-readable, storage device of claim 11 wherein the instructions that cause the lighting control circuitry to determine whether the received target intensity is greater than the defined threshold intensity value that corresponds to a minimum load current of an operatively coupled lighting load further cause the lighting control circuitry to:
retrieve from operatively coupled memory circuitry, data representative of a low-end intensity of the operatively coupled lighting load that corresponds to a low-end trim value; and
compare the received target intensity to the retrieved low-end intensity to determine whether the received target intensity is greater than the defined threshold intensity value.
